(19) United States
(12) Patent Application Publication
(10) Pub. No.: US 2026/0329532 A1
(43) Pub. Date: Oct. 22, 2026

(54) SHIFT-AND-ADD BASED 4-BIT FLOATING-POINT DOT-PRODUCT CIRCUIT ARCHITECTURE

(71) Applicant: Intel Products IP LLC, Santa Clara, CA (US)

(72) Inventor: Umer Iftikhar Cheema, Portland, OR (US)

(73) Assignee: Intel Products IP LLC, Santa Clara, CA (US)

(21) Appl. No.: 19/690,256

(22) Filed: May 28, 2026

(51) Int. Cl. G06F 7/487; G06F 7/485

(52) U.S. Cl. CPC G06F 7/4876; G06F 7/485

(57) ABSTRACT

A shift-and-add (SHAD) based architecture can compute FP4 dot-products without mantissa multiplication. Encoding is applied to re-represent an FP4 value in a scaled integer-domain as m×2^{k}, where m∈{1, 3} and k is a compact exponent field. Because the mantissa factor has only two possible non-zero values, the product of any two encoded operands is constrained to the set {0, 1, 3, 9}, enabling selection-based product generation followed by exponent-derived shifting, which replaces conventional multiplier logic with lightweight multiplexer and shift circuitry. Accumulation proceeds in the integer-domain, and a fixed right-shift compensates for encoding stage scaling. Synthesis results on a block normalized adder (BNA) macro demonstrate over 15% gate count reduction and comparable power savings relative to prior integer-recoding approaches, while maintaining equivalent throughput. The architecture is particularly suited to area- and power-constrained AI accelerator datapaths.

### BACKGROUND

Neural network (NN) hardware accelerators are specialized computing systems designed to execute neural network operations more efficiently than general-purpose processors. These accelerators may include many parallel compute units, local memory structures, data movement circuitry, and control logic arranged to process large numbers of arithmetic operations with high throughput and reduced energy consumption.

Dot-product circuits are common building blocks in neural network hardware accelerators because many neural network computations involve multiplying corresponding input values and weight values and accumulating the resulting products. A dot-product circuit may include multiple lanes that generate individual products and combination circuitry, such as an adder tree, that combines the products into a dot-product value used by downstream neural network processing.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates a NN hardware accelerator, according to some examples of the disclosure.

FIG. 2 illustrates an encoding table to convert a 4-bit floating-point (FP4) representation to a shift-and-add (SHAD) encoded representation, according to some examples of the disclosure.

FIG. 3 illustrates an FP4 to SHAD encoding stage and a dot-product pipe, according to some examples of the disclosure.

FIG. 4A illustrates an array of encoders, according to some examples of the disclosure.

FIG. 4B illustrates a shared array of encoders, according to some examples of the disclosure.

FIG. 5 illustrates M instances of a SHAD multiply element and an M:1 combiner in a dot-product circuit, according to some examples of the disclosure.

FIG. 6 illustrates example implementations of a post processing stage, according to some examples of the disclosure.

FIG. 7 illustrates a multiplier-less process for computing a dot-product, according to some examples of the disclosure.

FIG. 8 illustrates a method for performing a SHAD-based multiplication, according to some examples of the disclosure.

FIG. 9 is a block diagram of an exemplary computing device, according to some examples of the disclosure.

### DETAILED DESCRIPTION

### Overview

Conventional FP4 dot-product implementations can incur hardware overhead when they convert FP4 operands into wider integer-like forms or process them using floating-point multiplication operations. In particular, conventional approaches may require mantissa multiplication, hidden-bit handling, radix-point alignment, post-multiplication normalization, or wider intermediate datapaths. These costs are significant in NN hardware accelerators because FP4 dot-product circuits are heavily replicated across execution units and compute cores, so even small per-lane inefficiencies can scale into substantial area and power penalties.

To address one or more of these issues, a multiplier-less shift-and-add approach for FP4 dot-products can be implemented as the multiplier elements in a dot-product pipe. In some examples, a dot-product circuit includes an encoding stage, a product generation circuit having multiple lanes, and a lane product combination circuit. The encoding stage receives floating-point multipliers and multiplicands as operands and outputs encoded multipliers and encoded multiplicands as encoded operands. Each encoded operand includes a sign bit, two exponent bits, and a mantissa bit indicating whether a mantissa factor corresponds to 1 or 3. This representation advantageously preserves the power-of-two structure of FP4 values while reducing the non-exponent portion of each non-zero operand to a one-bit mantissa factor indication.

The encoding is based on representing a scaled FP4 value as m×2^{k}, where m is limited to 1 or 3 and k is represented by two exponent bits. The mantissa bit therefore does not encode a general mantissa; it indicates which of the two possible mantissa factors is present. This permits the FP4 input value to be carried through the dot-product datapath in a compact sign-exponent-mantissa-bit form, instead of expanding the operand into a wider INT5-style representation. Zero may be handled separately using zero-detection logic or a zero-gating signal, so the non-zero product datapath can be optimized for only the 1 and 3 mantissa factor cases.

In some examples, within a lane of the product generation circuit, a product selector circuit generates the unsigned mantissa product value. Because an operand's mantissa factor is either 1 or 3, the non-zero mantissa product can be restricted to 1, 3, or 9. Thus, the lane does not require a conventional mantissa multiplier. Instead, the product selector circuit, which may be implemented as a multiplexer or equivalent selection logic to select from a small set of values based on the mantissa bit and the further mantissa bit. When zero-gating is used, the product selector circuit may select from a set having {0, 1, 3, 9}, with 0 selected when at least one encoded operand represents zero.

In some examples, the lane also determines the shift amount from the exponent fields (an exponent field has two bits). An exponent addition circuit adds the two exponent bits of the encoded multiplier and the two exponent bits of the encoded multiplicand to produce a shift amount. Since each two-bit exponent field represents a value in the relevant encoded range, the resulting shift amount is bounded, for example from 0 to 6, and may be represented by three bits. A shifter then applies this shift amount to the selected mantissa product value, thereby implementing multiplication by the combined power-of-two factor through shifting rather than through a full multiplier.

In some examples, sign handling is separated from the unsigned mantissa product selection. An exclusive-OR (XOR) circuit determines the sign of the lane product from the sign bit of the encoded multiplier and the sign bit of the encoded multiplicand. A two's-complement transformation circuit can conditionally transform the selected unsigned mantissa product value based on that product sign, producing a signed representation before shifting. This division of labor keeps the product selector circuit small and unsigned while still allowing the lane to output signed products suitable for accumulation.

In some examples, the lane products are combined by a lane product combination circuit, such as an integer adder tree. Because the encoding and product generation process keep the values in an integer representation, the dot-product summation or accumulation operation can be performed using integer addition rather than floating-point addition. This avoids repeated exponent alignment or normalization associated with floating-point addition and allows the dot-product circuit to combine many lane products efficiently.

In some examples, the architecture may be arranged and organized hierarchically. Multiple product generation circuits may each produce a dot-product or partial dot-product through corresponding lane product combination circuits, and a higher-level combiner circuit may combine those dot-product or partial dot-product outputs. This hierarchical organization allows the same multiplier-less lane structure to be replicated at different granularities, such as within a multi-lane dot-product block, across multiple dot-product blocks in an execution unit, and across multiple execution units in a compute core. For example, each product generation circuit may include a group of lanes that generate signed, shifted lane products using product selection and exponent-sum shifting, and each corresponding lane product combination circuit may locally accumulate those lane products using an integer adder tree. The resulting local dot-product or partial dot-product outputs may then be provided to a higher-level adder, accumulator, or other combiner circuit to form a wider dot-product result, a block-level accumulation result, or an input to a subsequent scaling or post processing stage.

In some examples, this organization supports accelerator designs in which compute cores include many replicated FP4 dot-product circuits because the same compact product generation logic can be tiled across the core without introducing a conventional mantissa multiplier in each lane. Local accumulation can be performed near the lanes that generate the products, which may reduce routing complexity and allow the widths of intermediate signals to be controlled at each level of the hierarchy. The higher-level combiner circuit can then aggregate partial results from multiple local dot-product circuits while preserving the benefits of the encoding, including selection from a limited set of mantissa product values, bounded exponent-derived shifting, zero-gated product generation, and integer-domain accumulation. This allows the architecture to scale from a single dot-product lane to larger block normalized adder (BNA)-style blocks, multi-block execution units, and compute-core-level FP4 datapaths while maintaining reduced area and power relative to architectures that replicate wider integer or floating-point multiplier structures. As used herein, a BNA may refer to a dot-product circuit that generates a plurality of lane products from corresponding pairs of input operands and combines the lane products to produce a dot-product, partial dot-product, or block-level accumulated value.

In some examples, a post processing circuit may compensate for scaling introduced by the encoding stage. Because the encoding may scale each FP4 operand by a factor of two to keep fractional FP4 values in an integer-domain representation, the product of two encoded operands carries a corresponding factor of four. Rather than compensating before lane accumulation, the architecture can defer the correction until after the lane products are combined, then apply a right-shift of two bit positions to the accumulated sum. This advantageously preserves integer-domain accumulation while restoring the intended dot-product scale.

In some examples, the post processing circuit may apply one or more block scaling factors to the dot-product output. For example, the input operands may be associated with a block-scaled FP4 format, such as MXFP4, NVFP4, or another format in which a group of FP4 values shares one or more scale values. Block-scaled FP4 formats may include MXFP4, NVFP4, or other formats in which multiple FP4 values share one or more scale factors. In MXFP4, the shared scale factor may be represented as an exponent-only value, such as E8M0, while in NVFP4, the shared scale factor may be represented using a floating-point value having both exponent and mantissa bits, such as E4M3. The multiplier-less product generation path may generate and accumulate products of the encoded FP4 values, while the post processing circuit applies the corresponding scale value or scale values to the resulting dot-product or partial dot-product output.

In some examples, applying the block scaling factors after the lane products have been combined allows the core product generation path to remain focused on the compact encoded FP4 representation. For example, the lanes may continue to use sign bits, exponent sums, mantissa factor selection, zero-gating, shifting, and integer addition to generate and combine FP4 lane products. The scaling factors may be applied in different ways depending on the scale format, such as by exponent adjustment or shifting for power-of-two scale formats and by fixed-point or floating-point multiplication for scale formats that include mantissa information. The scaling operation may then be handled outside the per-lane product selector path, which can advantageously reduce duplication of scaling hardware and allow the same multiplier-less FP4 dot-product architecture to be used in accelerator pipelines that support block-scaled FP4 variants.

The SHAD architecture and approach are broadly applicable to NN hardware accelerators, AI accelerators, graphics processors, neural network execution units, and other compute systems that perform large numbers of FP4 dot-products. The SHAD architecture may be implemented with one or more features such as per-operand encoders, shared encoder banks, pre-encoded operands, local zero-detection logic, precomputed zero-gating signals, mux-based product selectors, or equivalent logic structures. Various implementation features provide flexibility in balancing timing, area, routing, and datapath organization.

The technical benefit is that the architecture replaces FP4 mantissa multiplication with selection among a small finite set of mantissa product values, replaces power-of-two multiplication with bounded shifts derived from exponent sums, and performs accumulation in an integer representation. This reduces multiplier logic, limits intermediate widths, avoids FP-specific normalization overhead, decreases switching activity through zero-gating, and can reduce area and power while maintaining dot-product throughput in highly replicated FP4 compute hardware.

The architecture provides a specific technical improvement to the operation of FP4 dot-product hardware by changing how each lane represents, generates, and accumulates products. The encoding stage represents each non-zero FP4 operand using a sign bit, two exponent bits, and a mantissa bit indicating whether the mantissa factor corresponds to 1 or 3, which allows the circuit to preserve the power-of-two structure of FP4 values without expanding each operand into a wider integer multiplication format. Rather than using a conventional mantissa multiplier for each FP4 operand pair, the lane uses the encoded mantissa bits and any zero-gating signal to select from a limited set of possible unsigned mantissa product values, such as {1, 3, 9} or {0, 1, 3, 9}. The lane also uses the encoded exponent bits to generate a bounded shift amount, so multiplication by the exponent-derived power-of-two factor can be performed by a controlled shift rather than by general multiplication.

The resulting signed, shifted lane products can be accumulated in an integer representation by the lane product combination circuit. This reduces the amount of multiplication circuitry in each lane, limits the width and complexity of portions of the product generation datapath, simplifies shifter control because the shift amount is bounded, avoids repeated floating-point radix-point alignment and normalization operations during product generation and accumulation, and allows zero-valued operands to be gated before unnecessary switching occurs. Post processing, such as right-shift compensation or scale application, may be performed after lane product accumulation so that the per-lane product generation path remains optimized for product selection, exponent-sum shifting, and integer addition. In one evaluated implementation, the architecture reduced gate count and power relative to an existing FP4 dot-product implementation while maintaining the same throughput. Because FP4 dot-product lanes and dot-product blocks are replicated many times in an accelerator, these per-lane and per-block circuit improvements can reduce aggregate area, dynamic power, and routing complexity while preserving dot-product throughput.

### NN Hardware Accelerator

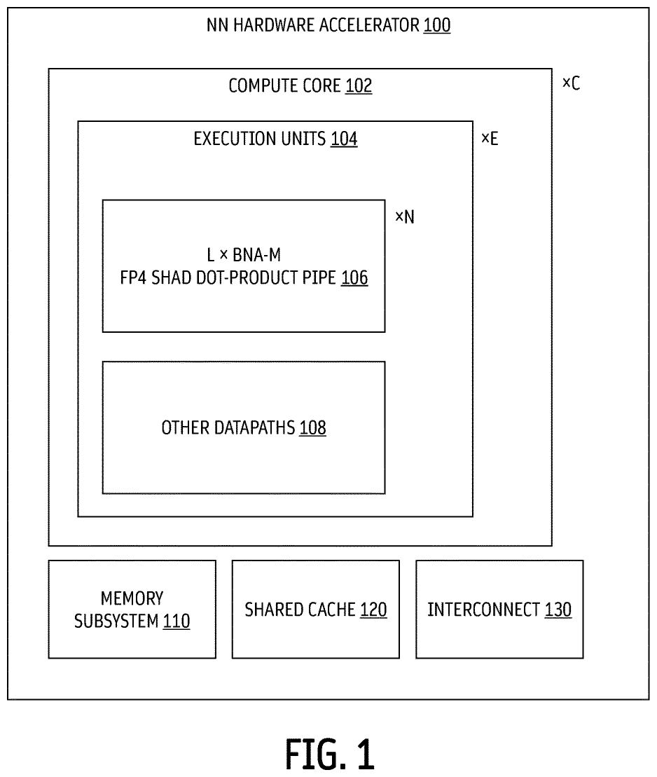

FIG. 1 illustrates NN hardware accelerator 100, according to some examples of the disclosure. NN hardware accelerator 100 may include one or more compute cores 102, memory subsystem 110, shared cache 120, and interconnect 130. NN hardware accelerator 100 may be implemented as, or as part of, a neural network accelerator, graphics processing unit, artificial intelligence accelerator, tensor processor, machine learning processor, system-on-chip, or other processor or integrated circuit that can perform arithmetic operations for neural network workloads.

Compute core 102 can include one or more execution units 104. In some examples, NN hardware accelerator 100 may include C instances of compute core 102. In some examples, compute core 102 may include E instances of execution unit 104. Compute core 102 may execute arithmetic operations, matrix operations, vector operations, dot-product operations, convolution operations, activation operations, data movement operations, or other operations associated with neural network processing.

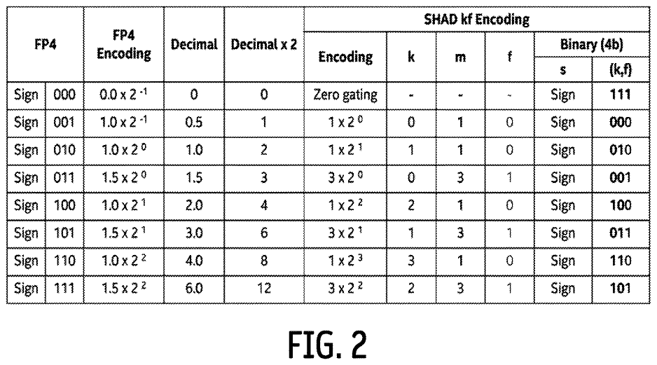

In some examples, execution unit 104 can include one or more FP4 SHAD dot-product pipes 106. In some examples, execution unit 104 can include one or more other datapaths 108. In some examples, execution unit 104 may include N instances of FP4 SHAD dot-product pipe 106. FP4 SHAD dot-product pipe 106 may include L instances of a BNA-M structure. As used herein, BNA-M may refer to a block normalized adder structure having M lanes, inputs, products, or accumulation positions. FP4 SHAD dot-product pipe 106 may perform FP4 dot-product operations using multiplier-less shift-and-add product generation and lane product accumulation, as described and illustrated in greater detail with FIGS. 2-8.

Other datapaths 108 may include one or more datapaths different from FP4 SHAD dot-product pipe 106. For example, other datapaths 108 may support integer arithmetic, floating-point arithmetic, vector operations, matrix operations, scalar operations, format conversion, activation processing, load/store processing, or other operations used by execution unit 104. Other datapaths 108 may operate in parallel with, share resources with, or exchange data with FP4 SHAD dot-product pipe 106.

Memory subsystem 110 may store operands, weights, activations, intermediate values, output values, instructions, control information, or other data used by NN hardware accelerator 100. Shared cache 120 may store data shared among compute cores 102, execution units 104, FP4 SHAD dot-product pipes 106, other datapaths 108, or other components of NN hardware accelerator 100. Interconnect 130 may provide communication paths among compute core 102, memory subsystem 110, shared cache 120, and other components of NN hardware accelerator 100.

In some examples, FP4 SHAD dot-product pipe 106 may be replicated within execution unit 104, execution unit 104 may be replicated within compute core 102, and compute core 102 may be replicated within NN hardware accelerator 100. This hierarchical organization allows FP4 dot-product capability to scale across NN hardware accelerator 100 while allowing memory subsystem 110, shared cache 120, and interconnect 130 to provide data storage and movement support for the replicated compute resources.

In some examples, C, E, N, L, and M may have any suitable positive integer values. For example, NN hardware accelerator 100 may include 2, 4, 8, 16, or more compute cores 102 corresponding to C; each compute core 102 may include 2, 4, 8, or more execution units 104 corresponding to E; each execution unit 104 may include 1, 2, 4, 8, or more FP4 SHAD dot-product pipes 106 corresponding to N; each FP4 SHAD dot-product pipe 106 may include 1, 2, 3, 4, or more BNA-M structures corresponding to L; and each BNA-M structure may include 8, 16, 32, 64, or another number of lanes, inputs, products, or accumulation positions corresponding to M. These values are provided as non-limiting examples, and other values are envisioned. The values of C, E, N, L, and M may be selected or varied based on one or more design factors, including target throughput, area budget, power budget, memory bandwidth, workload characteristics, supported data formats, clock frequency, routing constraints, die size, thermal limits, or a desired balance between compute density and data movement resources.

### FP4 to SHAD kf Encoding

In some examples, the SHAD encoding represents each non-zero FP4 operand in a scaled integer-domain form. Let x denote an FP4 operand magnitude. The encoding first forms a scaled value:

x_s=2x

The scaling by two converts the supported FP4 E2M1 magnitudes into integer values. For example, FP4 magnitudes {0.5, 1.0, 1.5, 2.0, 3.0, 4.0, 6.0} are converted into scaled values {1, 2, 3, 4, 6, 8, 12}.

Each non-zero scaled value xₛ is then represented in the form: xₛ=m×2^{k}
where: m∈{1, 3} and k={0, 1, 2, 3}.

Thus, the scaled FP4 values may be encoded as follows:

1=1×2⁰

2=1×2¹

3=3×2⁰

4=1×2²

6=3×2¹

8=1×2³

12=3×2²

Because mantissa factor m has only two possible values, m may be represented by a single mantissa bit f. In some examples: f=0 indicates m=1 and f=1 indicates m=3.

Accordingly, an encoded FP4 operand may be represented using a sign bit s, two exponent bits representing k, and one mantissa bit f. The sign bits may be propagated from the original FP4 operand, while the remaining bits encode the scaled magnitude in m×2^{k} form.

For two encoded operands A and B, the scaled magnitudes may be represented as:

As=mA×2^{kA} and Bs=mB×2^{kB}.

Their product is: As·Bs=(mA×2^{kA})×(mB×2^{kB})
which can be rewritten as: As×Bs=(mA×mB)·2^{kA+kB}.

Because each of mA and mB is either 1 or 3, the non-zero mantissa product mA×mB can only be one of: {1, 3, 9}.

Thus, the lane does not need a general or conventional mantissa multiplier. The lane may select an unsigned mantissa product value from {1, 3, 9} based on the mantissa bits of the two encoded operands. If zero-gating is used, the lane may select from {0, 1, 3, 9}, with 0 selected when at least one operand represents zero.

The exponent contribution to the product is handled by adding the encoded exponent values: kP=kA+kB.

Because each encoded exponent value is represented using two bits, kP may be represented as a bounded shift amount. In some examples, kP ranges from 0 to 6.

The scaled product can therefore be generated as: Ps=mP<<kP
where: mP=mA×mB and kP=kA+KB.

If sign is considered, the sign of the product may be determined from the operand signs, for example by XORing the sign bits. The selected unsigned mantissa product value may then be conditionally transformed into a signed representation before applying the shift amount.

Because each input operand was scaled by two, the product of two encoded operands includes a factor of four relative to the original FP4 product. Therefore, after lane products are accumulated, a post processing circuit may apply a right-shift of two bit positions to compensate for the introduced scaling factor.

FIG. 2 illustrates an encoding table to convert a 4-bit floating-point (FP4) representation to a shift-and-add (SHAD) encoded representation, according to some examples of the disclosure. FP4 representation may include a sign bit and three remaining bits corresponding to an E2M1 floating-point value. The table shows, for each possible three-bit FP4 magnitude encoding, corresponding decimal value, scaled integer value, SHAD kf encoding, and resulting four-bit binary representation. In some examples, sign bit may be propagated without change from FP4 representation to SHAD encoded representation, while remaining FP4 bits may be converted into exponent bits k and mantissa bit f.

The FP4 encoding column identifies example E2M1 values represented by the three non-sign bits of FP4 representation. For example, FP4 encoding 001 corresponds to 1.0×2⁻¹, FP4 encoding 010 corresponds to 1.0×2⁰, FP4 encoding 011 corresponds to 1.5×2⁰, FP4 encoding 100 corresponds to 1.0×2¹, FP4 encoding 101 corresponds to 1.5×2¹, FP4 encoding 110 corresponds to 1.0×2², and FP4 encoding 111 corresponds to 1.5×2². FP4 encoding 000 corresponds to zero and may be treated as a special case.

The decimal column shows numeric values represented by corresponding FP4 encodings. Because FP4 E2M1 values may include fractional values, such as 0.5 and 1.5, decimal×2 column shows corresponding values after multiplication by two. This scaling converts supported FP4 magnitudes into integer values for subsequent product generation and accumulation. For example, decimal values 0.5, 1.0, 1.5, 2.0, 3.0, 4.0, and 6.0 become scaled values 1, 2, 3, 4, 6, 8, and 12, respectively. This scaling enables an integer representation to be used in downstream dot-product circuitry, with compensation for introduced scaling applied in post processing, when appropriate.

The SHAD kf encoding column represents each non-zero scaled value in form m×2^{k}, where mantissa factor m is limited to either 1 or 3 and exponent value k is represented by two exponent bits. For example, scaled value 1 is represented as 1×2⁰, scaled value 2 is represented as 1×2¹, scaled value 3 is represented as 3×2⁰, scaled value 4 is represented as 1×2², scaled value 6 is represented as 3×2¹, scaled value 8 is represented as 1×2³, and scaled value 12 is represented as 3×2². By choosing representations in which m is only 1 or 3, SHAD encoded representation allows mantissa information to be captured using a single mantissa bit f.

The mantissa bit (or flag) f indicates whether mantissa factor m corresponds to 1 or 3. In some examples, f has value 0 (or a first value) when m corresponds to 1, and f has value 1 (or a second value) when m corresponds to 3. Accordingly, values having SHAD encodings 1×2⁰, 1×2¹, 1×2², and 1×2³ have f equal to 0, while values having SHAD encodings 3×2⁰, 3×2¹, and 3×2² have f equal to 1. This one-bit mantissa factor indication supports product selection in later circuitry because product of two non-zero mantissa factors can be selected from a limited set of values rather than generated using a general mantissa multiplier.

The binary column shows example four-bit SHAD encoded representation including sign bit s and three bits corresponding to (k,f). In some examples, encoded multiplier or encoded multiplicand may include sign bit s, two exponent bits k, and mantissa bit f. For example, FP4 magnitude encoding 001 may be converted to (k,f)=000, FP4 magnitude encoding 010 may be converted to (k,f)=010, FP4 magnitude encoding 011 may be converted to (k,f)=001, FP4 magnitude encoding 100 may be converted to (k,f)=100, FP4 magnitude encoding 101 may be converted to (k,f)=011, FP4 magnitude encoding 110 may be converted to (k,f)=110, and FP4 magnitude encoding 111 may be converted to (k,f)=101. These values are examples of bit assignments for carrying k and f, and other bit orders or logically equivalent encodings may be used.

The zero value may be handled using zero-gating. As shown in FIG. 2, FP4 magnitude encoding 000 may correspond to zero-gating rather than to non-zero SHAD kf encoding. In some examples, zero-detection logic may generate a zero-gating signal based on the original FP4 operand, or another representation of operand value (e.g., encoded multiplier, or encoded multiplicand). The zero-gating signal may cause a downstream product selector circuit to select an unsigned mantissa product value of 0 when at least one operand represents zero. In some examples, an unused binary value, such as (k,f)=111, may be used as a zero indication when local zero-detection or local zero representation is desired.

In some examples, the zero-gating signal can be used for more than selecting 0 as the unsigned mantissa product value. Within the multiply circuit, the zero-gating signal may disable or bypass downstream product generation activity when at least one operand represents zero, such as by preventing unnecessary toggling in one or more of: the product selector circuit, sign-generation logic, two's-complement transformation circuit, shifter, or lane product output registers. The zero-gating signal may also be used to force the lane product to a known zero value before the lane product is provided to the lane product combination circuit, which can reduce switching activity in the integer adder tree or accumulation path. In some examples, the zero-gating signal may serve as a local validity or bypass indication for the lane, so that the circuit avoids computing, shifting, or accumulating a product that is known in advance to be zero.

The encoding stage can be implemented in at least two ways: as a small look-up table or as combinational logic derived from the FP4 E2M1 input bits.

For a look-up table implementation, the encoder receives the three non-sign FP4 bits, shown as E2M1 in the encoding table of FIG. 2, and directly maps each possible value to the corresponding (k,f) value. The sign bit can be passed through separately. In this implementation, the encoder may include a simple eight-entry table indexed by the FP4 magnitude bits. Each entry outputs two exponent bits k[1:0] and one mantissa bit f. The output may be combined with the original sign bit to form the encoded operand, for example as {sign, k[1:0], f}. Zero may be represented by a reserved (k,f) code, such as 111, or may be handled by a separate zero-gating signal.

The same mapping can also be implemented using combinational logic rather than a table. For example, the three non-sign FP4 bits are treated as E2M1 [2:0], and the encoder derives the two exponent bits and the mantissa bit as:

k[1]=E2M1[2]|(E2M1[1] & ~E2M1[0])

k[0]=E2M1[1]\hat{ }E2M1[0]

f=E2M1[0] & (E2M1[2]|E2M1[1])

This logic produces the same (k,f) values shown in the encoding table for the non-zero FP4 inputs. The f expression identifies the FP4 encodings whose scaled values have mantissa factor m=3, namely the cases corresponding to 3×2⁰, 3×2¹, and 3×2². The k[1:0] expressions generate the exponent value used later to form the shift amount.

For example, for FP4 magnitude 101, which represents decimal 3.0, the scaled value is 6, which is encoded as: 6=3×2¹

So the SHAD fields are:

k=1

f=1

(k,f)=011

The logic gives the same result:

k[1]=1|(0 & ~1)=1

k[0]=0\hat{ }1=1

f=1 & (1|0)=1

Thus, (k,f)=011.

For FP4 magnitude 110, which represents decimal 4.0, the scaled value is 8, which is encoded as:

8=1×2³

So:

k=3

f=0

(k,f)=110

The logic gives:

k[1]=1|(1 & ~0)=1

k[0]=1\hat{ }0=1

f=0 & (1|1)=0

Thus, (k,f)=110.

The look-up table approach may follow the FP4-to-SHAD mapping table as illustrated in FIG. 2. The combinational logic approach may be more hardware efficient because the approach avoids storing or decoding a table and instead generates the SHAD exponent and mantissa factor bits using a small number of logic gates. Either implementation provides an encoding stage that outputs a sign bit, two exponent bits, and a mantissa bit indicating whether the mantissa factor corresponds to 1 or 3, thereby preparing the operands for multiplier-less product generation using product selection and exponent-sum shifting.

Encoding shown in FIG. 2 supports multiplier-less FP4 product generation. Because each non-zero encoded operand has a mantissa factor m of 1 or 3, a product selector in a product generation lane may select an unsigned mantissa product value from 1, 3, or 9 based on mantissa bit f of the encoded multiplier and further mantissa bit f of the encoded multiplicand. Exponent addition circuit may generate a shift amount from the sum of exponent bits k of the encoded multiplier and encoded multiplicand. Thus, the encoded representation shown in FIG. 2 provides operands suitable for generating lane products using mantissa product selection, sign handling, exponent-sum shifting, and integer-domain accumulation.

### Circuit to Perform FP4 to SHAD Encoding and Dot-Product Generation

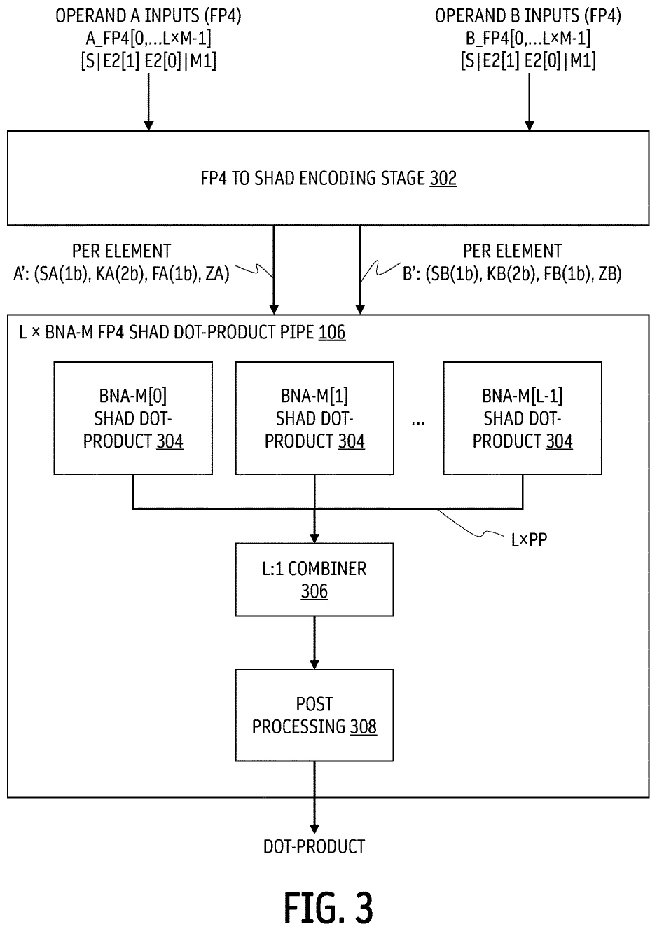

FIG. 3 illustrates FP4 to SHAD encoding stage 302 and dot-product pipe 106, according to some examples of the disclosure. FP4 to SHAD encoding stage 302 receives operand A inputs and operand B inputs in FP4 format. In some examples, operand A inputs may include A_FP4 [0, . . . , L×M−1], and operand B inputs may include B_FP4 [0, . . . , L×M−1]. Each FP4 input may include a sign bit S, exponent bits E2[1] and E2[0], and a mantissa bit M1.

In some examples, FP4 to SHAD encoding stage 302 converts operand A inputs and operand B inputs from FP4 format into per-element SHAD encoded operands. For operand A inputs, FP4 to SHAD encoding stage 302 may output per-element encoded operand values A′, where an encoded operand value A′ includes a sign bit SA (1-bit or 1b), an exponent value KA (2-bit or 2b), a mantissa factor bit FA (1b), and optionally a zero indication ZA. For operand B inputs, FP4 to SHAD encoding stage 302 may output per-element encoded operand values B′, where an encoded operand value B′ includes a sign bit SB (1b), an exponent value KB (2b), a mantissa factor bit FB (1b), and optionally a zero indication ZB. In some examples, sign bits SA and SB may each be one bit, exponent values KA and KB may each be two bits, mantissa factor bits FA and FB may each be one bit, and zero indications ZA and ZB may indicate whether the corresponding encoded operands represent zero.

Encoded operand values A′ and B′ are provided to the L×BNA-M FP4 SHAD dot-product pipe 106. In some examples, dot-product pipe 106 includes one or more BNA-M SHAD dot-product circuits 304, shown as BNA-M[0], BNA-M[1], and BNA-M[L-1], with an ellipsis indicating that one or more intermediate BNA-M SHAD dot-product circuits 304 may be included. A BNA-M SHAD dot-product circuit 304 may receive a corresponding group of M encoded operand pairs and may generate a partial product, partial dot-product, or local dot-product output for that group.

In some examples, dot-product pipe 106 includes L instances of BNA-M SHAD dot-product circuits 304. A BNA-M SHAD dot-product circuit 304 may receive M encoded operand pairs and may generate M lane products corresponding to M multiplications. Thus, the L×BNA-M FP4 SHAD dot-product pipe 106 may perform L×M multiplications for L×M corresponding operand pairs. The L×M multiplications may correspond to products of elements of operand A inputs and corresponding elements of operand B inputs. For example, BNA-M[0] may generate and combine M products for a first group of M operand pairs, BNA-M[1] may generate and combine M products for a second group of M operand pairs, and BNA-M[L-1] may generate and combine M products for an L-th group of M operand pairs. Each BNA-M SHAD dot-product circuit 304 may generate a partial dot-product by summing its M lane products. Outputs from BNA-M SHAD dot-product circuits 304 may be provided as L partial products or partial dot-products, shown as L×PP, to L:1 combiner 306. L:1 combiner 306 combines the L partial dot-products to generate a dot-product value corresponding to a sum of the L×M products. Stated differently, dot-product pipe 106 may compute a dot-product by multiplying L×M pairs of encoded operands and summing the resulting L×M products.

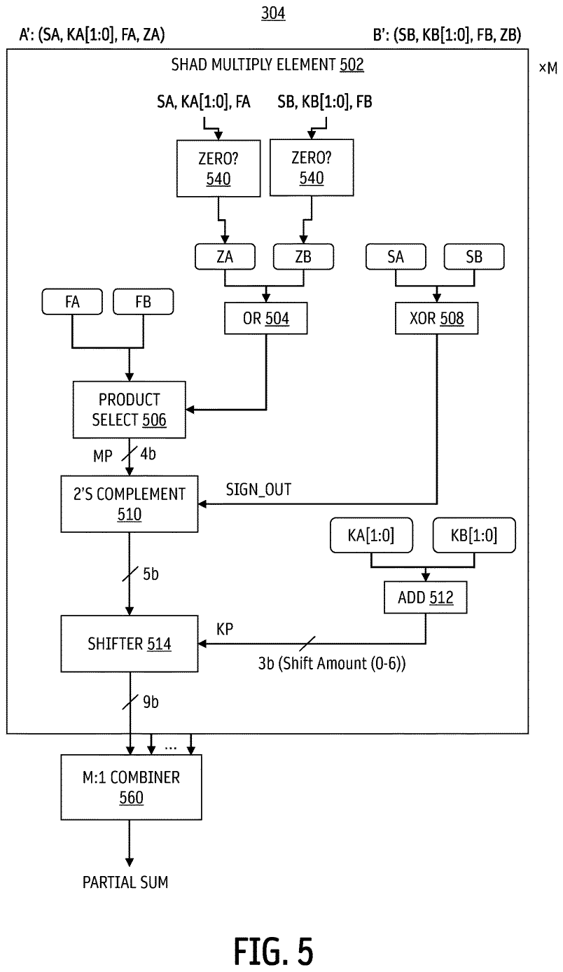

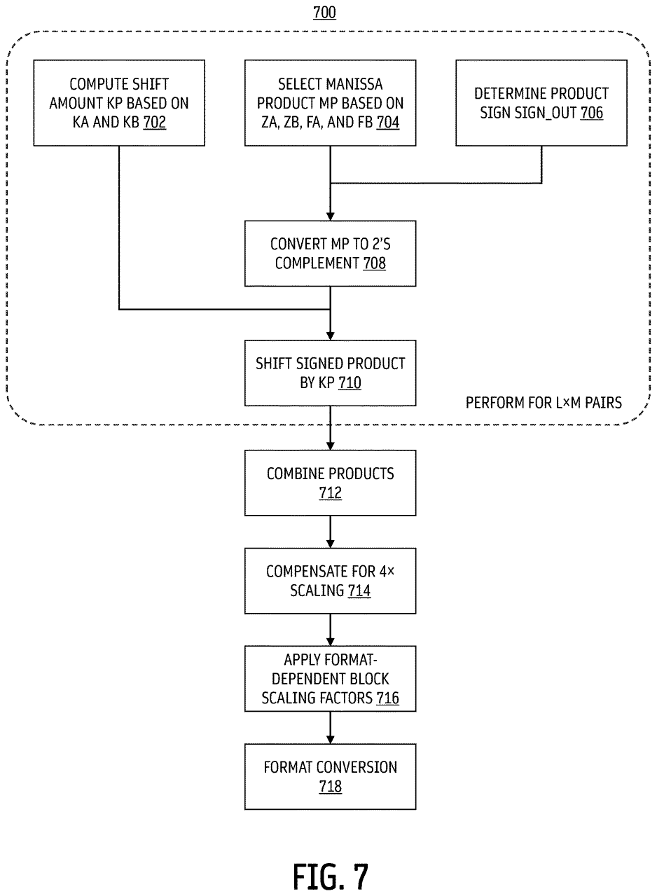

In some examples, a BNA-M SHAD dot-product circuit 304 may include multiple product generation lanes and a lane product combination circuit. For example, each product generation lane may use corresponding sign bits, exponent values, mantissa factor bits, and zero indications from encoded operands A′ and B′ to generate a lane product. Each BNA-M SHAD dot-product circuit 304 may combine M lane products to generate a corresponding partial dot-product output. At this architectural level, FIG. 3 shows BNA-M SHAD dot-product circuits 304 as repeated dot-product blocks within dot-product pipe 106, with more detailed lane-level product generation described and illustrated in FIGS. 5 and 7.

In some examples, outputs from one or more BNA-M SHAD dot-product circuits 304 may be provided as L partial products or partial dot-products, shown as L×PP, to L:1 combiner 306. L:1 combiner 306 combines outputs of BNA-M SHAD dot-product circuits 304 to generate a combined dot-product or accumulated dot-product value. In some examples, L:1 combiner 306 may include an adder tree, accumulator, reduction circuit, or other combination circuit suitable for combining multiple partial dot-product outputs.

In some examples, the output of L:1 combiner 306 may be provided to post processing 308. Post processing 308 may perform one or more operations on the combined dot-product value. For example, post processing 308 may apply a right-shift of two-bit positions to compensate for scaling introduced by FP4 to SHAD encoding stage 302. In some examples, post processing 308 may apply one or more block scaling factors associated with block-scaled FP4 formats. In some examples, post processing 308 can convert an intermediate accumulated representation to another numeric representation. In some examples, post processing 308 can provide formatting suitable for a downstream datapath.

Dot-product pipe 106 illustrates a hierarchical organization for FP4 dot-product computation. FP4 to SHAD encoding stage 302 can encode L×M operand pairs into compact per-element SHAD encoded operands, BNA-M SHAD dot-product circuits 304 can locally generate and combine lane products for respective groups of M operand pairs, and L:1 combiner 306 can combine L local outputs to produce a dot-product output. This organization advantageously allows dot-product pipe 106 to scale by varying L or M while preserving the same general encoding, local product generation, local accumulation, and higher-level combination structure.

### Varied Implementations of the Encoding Stage

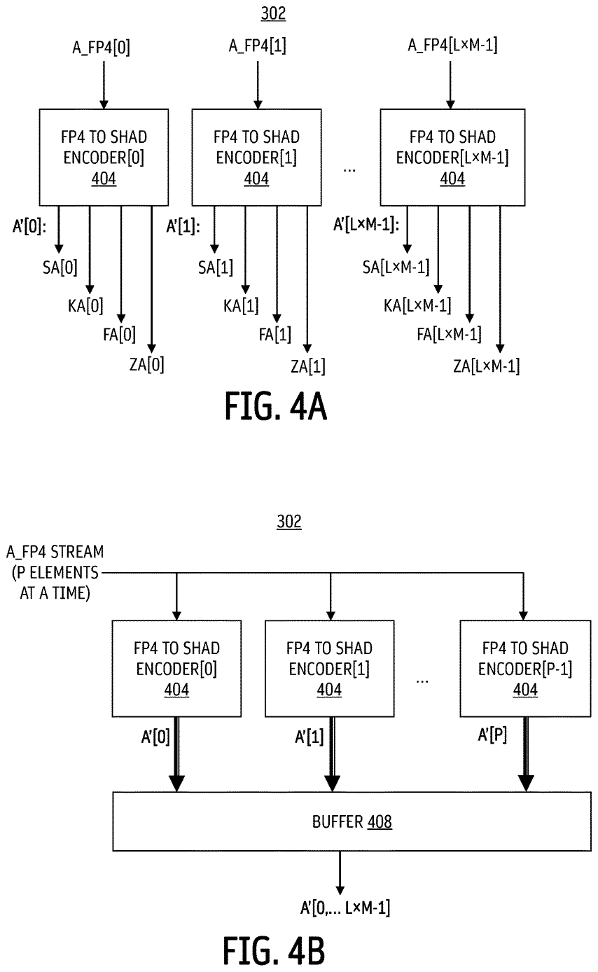

FIG. 4A illustrates an array of encoders 404 in SHAD encoding stage 302, according to some examples of the disclosure. SHAD encoding stage 302 may include multiple (e.g., L×M instances of) FP4 to SHAD encoders 404, shown as FP4 to SHAD encoder[0] 404, FP4 to SHAD encoder[1] 404, and FP4 to SHAD encoder[L×M−1] 404, with an ellipsis indicating that one or more additional FP4 to SHAD encoders 404 may be included between the illustrated encoders.

An FP4 to SHAD encoder 404 may receive a corresponding FP4 input operand from operand A inputs. For example, FP4 to SHAD encoder[0] 404 may receive A_FP4[0], FP4 to SHAD encoder[1] 404 may receive A_FP4[1], and FP4 to SHAD encoder[L×M−1] 404 may receive A_FP4 [L×M−1]. Each FP4 input operand may include a sign bit, exponent bits, and a mantissa bit, such as S, E2[1], E2[0], and M1.

An FP4 to SHAD encoder 404 may generate a corresponding encoded operand A′. For example, FP4 to SHAD encoder[0] 404 may generate A′[0], FP4 to SHAD encoder[1] 404 may generate A′[1], and FP4 to SHAD encoder[L×M−1] 404 may generate A′[L×M−1]. Each encoded operand A′ may include a sign bit SA, exponent value KA, mantissa factor bit FA, and optionally a zero indication ZA. In some examples, the sign bit SA may be propagated from a corresponding FP4 input operand, exponent value KA may include two exponent bits representing the SHAD exponent value k, mantissa factor bit FA may indicate whether the corresponding mantissa factor represents 1 or 3, and the optional zero indication ZA may indicate whether the corresponding FP4 input operand represents zero.

SHAD encoding stage 302 may provide per-element encoding for a group of L×M FP4 input operands. In some examples, each FP4 to SHAD encoder 404 may independently convert a corresponding FP4 input operand into an SHAD encoded representation, allowing L×M FP4 input operands to be encoded in parallel. Parallel encoding may support dot-product pipe 106 by providing encoded operands for L BNA-M dot-product circuits, each having M lanes or accumulation positions.

Although FIG. 4A illustrates FP4 to SHAD encoders 404 for operand A inputs, a same or similar encoder array may be used for operand B inputs. Operand A inputs are shown in FIG. 4A for simplicity of illustration. In some examples, separate encoder arrays may encode operand A inputs and operand B inputs in parallel. In other examples, one or more FP4 to SHAD encoders 404 may be shared, time-multiplexed, pipelined, or otherwise reused between operand A inputs and operand B inputs or between different groups of operands.

FP4 to SHAD encoder 404 may be implemented using a look-up table, combinational logic, programmable logic, hardwired logic, or a suitable combination thereof. For example, FP4 to SHAD encoder 404 may map FP4 magnitude bits to exponent value KA and mantissa factor bit FA using a small table corresponding to possible FP4 E2M1 magnitude encodings. As another example, FP4 to SHAD encoder 404 may generate KA and FA using Boolean logic derived from FP4 exponent and mantissa bits. In some examples, zero indication ZA may be generated locally by FP4 to SHAD encoder 404 or may be generated by separate zero-detection logic associated with SHAD encoding stage 302 or BNA-M SHAD dot-product circuit 304 of FIG. 3.

By generating sign bit SA, exponent value/field KA, mantissa factor bit FA, and optionally zero indication ZA on a per-element basis, SHAD encoding stage 302 prepares FP4 operands for downstream multiplier-less product generation. In particular, downstream product generation lanes may use mantissa factor bit FA, together with the corresponding mantissa factor bit from operand B, to select an unsigned mantissa product value; use exponent value KA, together with the corresponding exponent value from operand B, to generate a shift amount; and optionally use zero indication ZA, together with the corresponding zero indication from operand B, to gate or select zero-valued products.

FIG. 4B illustrates a shared array of encoders 404 in SHAD encoding stage 302, according to some examples of the disclosure. SHAD encoding stage 302 may receive an A_FP4 stream including P elements at a time. In some examples, P may be less than L×M, such that fewer FP4 to SHAD encoders 404 are used than the total number of encoded operands used by dot-product pipe 106 for a dot-product operation.

In some examples, SHAD encoding stage 302 may include multiple (e.g., P instances of) FP4 to SHAD encoders 404, shown as FP4 to SHAD encoder[0] 404, FP4 to SHAD encoder[1] 404, and FP4 to SHAD encoder[P−1] 404, with an ellipsis indicating that one or more additional FP4 to SHAD encoders 404 may be included between the illustrated encoders. Each FP4 to SHAD encoder 404 may receive a corresponding FP4 element from the A_FP4 stream and may output a corresponding encoded operand A′. For example, FP4 to SHAD encoder[0] 404 may output A′[0], FP4 to SHAD encoder[1] 404 may output A′[1], and FP4 to SHAD encoder[P−1] 404 may output A′[P−1].

In some examples, buffer 408 may receive encoded operands A′ output by FP4 to SHAD encoders 404 over multiple cycles, batches, beats, or other time intervals. Buffer 408 may store the encoded operands until the encoded operand set A′[0, . . . , L×M−1] is available for downstream dot-product processing. In this manner, SHAD encoding stage 302 may populate an encoded operand group for L×M operand positions using a shared or reduced number of FP4 to SHAD encoders 404.

In some examples, buffer 408 may decouple the rate at which FP4 operands are received and encoded from the rate at which encoded operands are consumed by dot-product pipe 106. For example, the A_FP4 stream may provide P FP4 elements per cycle, while dot-product pipe 106 may operate on an encoded operand group having L×M elements. Buffer 408 may therefore accumulate multiple groups of P encoded operands over multiple cycles and then provide L×M encoded operands to dot-product pipe 106 as a complete operand group.

In some examples, buffer 408 may also align encoded operands with corresponding lanes or BNA-M SHAD dot-product circuits 304. For example, encoded operands A′[0] through A′[M−1] may be provided to a first BNA-M SHAD dot-product circuit 304, encoded operands A′[M] through A′[2M−1] may be provided to a second BNA-M SHAD dot-product circuit 304, and so on until encoded operands A′[(L−1) M] through A′[L×M−1] are provided to an L-th BNA-M SHAD dot-product circuit 304. In this manner, buffer 408 may support mapping between streaming input order and lane or block order used by dot-product pipe 106.

In some examples, buffer 408 may store each encoded operand in compact SHAD form, including sign bit SA, exponent value KA, mantissa factor bit FA, and optionally zero indication ZA. Storing encoded operands rather than original FP4 operands may allow dot-product pipe 106 to receive operands already prepared for product selection, exponent-sum shifting, sign handling, and optional zero-gating. In other examples, buffer 408 may store one or more of: original FP4 bits, encoded SHAD bits, zero indications, validity bits, ordering metadata, or control information used to route encoded operands to appropriate lanes.

In some examples, buffer 408 may be implemented using suitable storage circuitry. For example, buffer 408 may include one or more of registers, latch arrays, flip-flop arrays, SRAM, queue storage, FIFO storage, circular-buffer storage, scratchpad storage. In some examples, buffer 408 may include one or more of write control logic to store encoded outputs from FP4 to SHAD encoders 404, read control logic to provide encoded operands to dot-product pipe 106, and validity or ready information to indicate when enough encoded operands have been collected for a dot-product operation.

In some examples, buffer 408 may include double buffering circuitry. For example, buffer 408 may include a first buffer region and a second buffer region, with one buffer region receiving encoded operands from FP4 to SHAD encoders 404 while the other buffer region provides a previously collected group of encoded operands to dot-product pipe 106. After dot-product pipe 106 consumes the encoded operands from one buffer region, the roles of the buffer regions may be exchanged. Double buffering may reduce stalls between encoding and dot-product execution, allow encoded operand collection to overlap with product generation and accumulation, and help maintain utilization of dot-product pipe 106 when the A_FP4 stream provides operands over multiple cycles.

In some examples, buffer 408 may support shared encoder operation by allowing a smaller number of encoders 404 to service a larger number of dot-product lanes. For instance, if P encoders 404 produce P encoded operands per cycle and dot-product pipe 106 uses L×M encoded operands for a dot-product operation, buffer 408 may collect encoded operands across multiple cycles until the L×M operand positions are filled. This can reduce encoder replication while still allowing dot-product pipe 106 to operate on a full group of encoded operands when the group becomes available.

The shared encoder arrangement shown in FIG. 4B may reduce encoder hardware relative to an arrangement in which a dedicated FP4 to SHAD encoder 404 is provided for each of the L×M operand positions. For example, P encoders may encode P incoming FP4 operands per cycle, and buffer 408 may collect encoded outputs over multiple cycles until L×M encoded operands have been generated. Such sharing may be useful when input operands arrive as a stream, when dot-product pipe 106 consumes operands in groups larger than input bandwidth, or when area, power, routing, or timing considerations favor fewer encoders with buffering.

Although FIG. 4B illustrates shared FP4 to SHAD encoders 404 for operand A inputs, a same or similar shared encoder arrangement may be used for operand B inputs. Operand A inputs are shown in FIG. 4B for simplicity of illustration. In some examples, separate shared encoder arrays and buffers may be used for operand A inputs and operand B inputs. In other examples, one or more FP4 to SHAD encoders 404 or buffer resources may be shared, time-multiplexed, pipelined, or otherwise reused between operand A inputs and operand B inputs or between different dot-product operations.

An encoded operand stored by buffer 408 may include a sign bit SA, exponent value KA, mantissa factor bit FA, and optionally zero indication ZA, as described above. Buffer 408 may output encoded operand set A′[0, . . . , L×M−1] to dot-product pipe 106 in an order suitable for mapping encoded operands to corresponding lanes of BNA-M SHAD dot-product circuits 304. In some examples, buffer 408 may include registers, latch arrays, queue storage, scratchpad storage, reorder storage, or other storage circuitry suitable for collecting and presenting encoded operands.

### Multiplier-Less FP4 Multiply Circuit

FIG. 5 illustrates M instances of SHAD multiply element 502 and an M:1 combiner 560 in an instance of BNA-M SHAD dot-product circuit 304 illustrated in FIG. 3, according to some examples of the disclosure. BNA-M SHAD dot-product circuit 304 may receive encoded operand A′ and encoded operand B′. Encoded operand A′ may include a sign bit SA, exponent value KA [1:0], a mantissa factor bit FA, and optionally zero indication ZA. Encoded operand B′ may include a sign bit SB, exponent value KB [1:0], a mantissa factor bit FB, and optionally zero indication ZB. In some examples, BNA-M SHAD dot-product circuit 304 may include M instances of SHAD multiply elements 502, and each SHAD multiply element 502 may correspond to a lane of a product generation circuit. Each lane may receive one encoded multiplier and one encoded multiplicand to generate one lane product.

In some examples, SHAD multiply element 502 may include one or more of zero-detection logic 540, OR circuit 504, product select 506, XOR circuit 508, two's complement circuit 510, add circuit 512, and shifter 514.

In some examples, zero-detection logic 540 may generate zero indication ZA or ZB from one or more fields of encoded operand A′ or encoded operand B′. In other examples, zero indication ZA or ZB may be generated by FP4 to SHAD encoding stage 302 and provided to SHAD multiply element 502, such that local zero-detection logic 540 may be omitted, bypassed, or used to validate the received zero indication.

In some examples, OR circuit 504 may receive zero indications ZA and ZB and may generate a zero-gating signal indicating whether at least one of encoded operand A′ or encoded operand B′ represents zero. The zero-gating signal may be provided to product select 506. In some examples, in response to the zero-gating signal indicating that at least one operand is zero, product select 506 may select unsigned mantissa product value MP as zero. In some examples, the zero-gating signal may be used to perform one or more of bypassing, disabling, and reducing switching in one or more of product generation logic, shifter logic, lane product output logic, and downstream accumulation logic when the corresponding lane product is known to be zero.

In some examples, product select 506 may receive mantissa factor bit FA of encoded operand A′ and mantissa factor bit FB of encoded operand B′. Product select 506 may select unsigned mantissa product value MP based on FA, FB, and optionally a zero-gating signal. For non-zero operands, FA and FB indicate whether respective mantissa factors correspond to 1 or 3, so unsigned mantissa product value MP may be selected from a set including 1, 3, and 9. In some examples, when the optional zero-gating signal is asserted, unsigned mantissa product value MP may be selected as 0. Accordingly, product select 506 may output MP as a 4-bit unsigned mantissa product value selected from a set including 0, 1, 3, and 9, thereby replacing general or conventional mantissa multiplication with selection logic.

In some examples, XOR circuit 508 may receive sign bit SA of encoded operand A′ and sign bit SB of encoded operand B′ and may determine sign output SIGN_OUT for a corresponding lane product. For example, XOR circuit 508 may indicate a negative lane product when sign bits SA and SB differ and may indicate a positive lane product when sign bits SA and SB are the same. SIGN_OUT may be provided to two's complement circuit 510.

In some examples, two's complement circuit 510 may receive unsigned mantissa product value MP from product select 506 and SIGN_OUT from XOR circuit 508. Two's complement circuit 510 may output a signed representation of MP based on SIGN_OUT. For example, two's complement circuit 510 may pass MP through when SIGN_OUT indicates a positive product and may conditionally invert MP and add one when SIGN_OUT indicates a negative product. In some examples, MP may be a 4-bit unsigned value, and two's complement circuit 510 may output a 5-bit signed representation to accommodate negative product values. The signed representation may be provided to shifter 514 so that sign handling is performed before exponent-sum shifting.

In some examples, add circuit 512 may receive exponent value KA [1:0] of encoded operand A′ and exponent value KB [1:0] of encoded operand B′ and may generate shift amount KP. In some examples, KP may be a three-bit value corresponding to a sum of KA [1:0] and KB [1:0]. Because KA and KB are bounded exponent values in SHAD encoded representation, KP may be bounded to a range of 0 to 6. KP may be represented using three bits and may be provided to shifter 514 as a shift amount. Representing KP as a bounded shift amount may simplify shifter control logic and may limit the range of shifted product values that shifter 514 needs to support.

In some examples, shifter 514 may receive the signed representation of MP from two's complement circuit 510 and shift amount KP from add circuit 512. Shifter 514 may shift the signed representation of MP by KP to generate a lane product. In some examples, shifter 514 may output a 9-bit lane product. The 9-bit output width may be sufficient because, under the SHAD encoding, the largest unsigned mantissa product value and the largest shift amount do not occur for the same encoded operand combination. Thus, shifter 514 may avoid a wider output datapath while still representing possible shifted lane products. Shifter 514 thereby generates the product of encoded operand A′ and encoded operand B′ using mantissa product selection, sign handling, and exponent-sum shifting.

In some examples, the ordering of two's complement circuit 510 and shifter 514 within SHAD multiply element 502 is arranged so that sign-magnitude conversion is performed on the unshifted mantissa product value MP before the exponent-derived shift is applied, rather than after. Specifically, two's complement circuit 510 receives the unsigned mantissa product value MP from product select 506, which is a compact value drawn from the set {0, 1, 3, 9} and may be represented in as few as four bits, and conditionally converts MP to a two's-complement signed representation based on SIGN_OUT. Because the two's-complement transformation is applied to this compact, unshifted value, the transformation circuitry operates on a narrow datapath (for example, converting a 4-bit unsigned mantissa product value to a 5-bit signed representation). Shifter 514 then left-shifts the 5-bit signed representation by the exponent-sum shift amount KP, with sign extension, to produce the wider lane product (for example, a 9-bit signed value). By contrast, in some other sign-magnitude multiplication datapaths, the product magnitude is typically determined first (e.g., by shifting or multiplying to produce the full-width unsigned product), and sign conversion is applied to the resulting wider value just before accumulation. In SHAD multiply element 502, applying two's-complement conversion before the shift advantageously confines the sign conversion logic to the narrow, pre-shift portion of the datapath, which can reduce the gate count, wiring, and dynamic switching activity of the two's-complement transformation circuitry relative to performing the same conversion on the wider post-shift lane product.

In some examples, M:1 combiner 560 may receive M lane products from M SHAD multiply elements 502, respectively, and may combine the lane products in an integer representation to generate a partial sum. In some examples, M:1 combiner 560 may include an integer adder tree, reduction tree, accumulator, carry-save adder structure, or other lane product combination circuit. The partial sum may correspond to a sum of M lane products generated by M SHAD multiply elements 502 within BNA-M SHAD dot-product circuit 304. The partial sum may correspond to a dot-product value because it represents a sum of M lane products generated from M corresponding pairs of encoded operands.

BNA-M SHAD dot-product circuit 304 therefore performs M multiplications by generating M lane products and summing those lane products to produce a partial sum. Each SHAD multiply element 502 avoids conventional mantissa multiplication by selecting an unsigned mantissa product value MP from a limited set of possible values and applying an exponent-derived shift amount KP. This structure changes product generation at the circuit level by replacing mantissa multiplier logic with product selection logic, replacing power-of-two multiplication with bounded shifting, and accumulating shifted lane products using integer combination circuitry. As a result, BNA-M SHAD dot-product circuit 304 may reduce multiplier logic, simplify shifter control, limit intermediate datapath widths, reduce unnecessary switching for zero-valued operands, and support signed FP4 lane products while maintaining dot-product throughput.

### Post Processing of Partial Sums

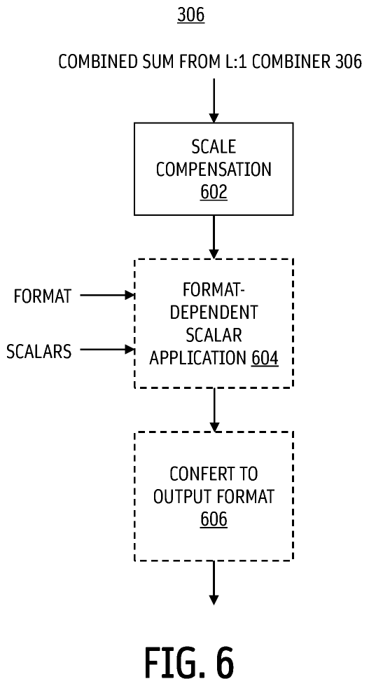

FIG. 6 illustrates example implementations of post processing 308, according to some examples of the disclosure. Post processing 308 may receive a combined sum from L:1 combiner 306 and may output a dot-product value in an output representation used by downstream circuitry. In some examples, the combined sum may correspond to the sum of L partial sums generated by L instances of BNA-M SHAD dot-product circuits, and therefore may correspond to a sum of L×M lane products. Post processing 308 may include scale compensation 602 and may optionally include format-dependent scalar application 604 and/or convert to output format 606. Dotted-line boxes for format-dependent scalar application 604 and convert to output format 606 indicate optional components or operations that may be included, omitted, bypassed, combined with other circuitry, or implemented elsewhere in an accelerator pipeline.

Scale compensation 602 may compensate for the scale factor introduced by FP4 to SHAD encoding stage 302. As described and illustrated in FIG. 2, SHAD encoding may multiply each FP4 operand magnitude by two before representing that scaled magnitude in the form m×2^{k}. When two encoded operands are multiplied, a product generated by SHAD multiply element 502 may therefore include a factor of four relative to the product of original FP4 operand magnitudes. Scale compensation 602 may remove or account for that factor of four after lane products have been combined. For example, scale compensation 602 may apply a right-shift of two-bit positions to the combined sum from L:1 combiner 306, adjust an exponent associated with the combined sum, change a binary-point position associated with the combined sum, or otherwise divide or rescale the combined sum by four.

In some examples, performing scale compensation 602 after L:1 combiner 306 may allow earlier portions of dot-product pipe 106 to operate in an integer representation. For example, SHAD multiply elements 502 illustrated in FIG. 5 may generate shifted lane products using selected mantissa product values and exponent-derived shift amounts, M:1 combiner 560 illustrated in FIG. 5 may combine lane products to produce partial sums, and L:1 combiner 306 illustrated in FIG. 3 may combine partial sums to produce a combined sum before scale compensation 602 is applied. Delaying scale compensation 602 until after combination by L:1 combiner 306 avoids introducing fractional values, binary-point alignment, or floating-point normalization into each SHAD multiply element 502 or each BNA-M SHAD dot-product circuit 304. This can reduce duplication of compensation logic across lanes, simplify local accumulation, and preserve multiplier-less product generation in integer-domain circuitry.

In some examples, scale compensation 602 may be implemented using any suitable arithmetic or representation-adjustment circuitry. In fixed-point or integer intermediate representations, scale compensation 602 may include a shifter, barrel shifter, wiring shift, arithmetic right shifter, rounding shifter, saturating shifter, truncation circuit, sticky-bit generation circuit, rounding increment circuit, sign extension circuit, or a combination thereof. In floating-point or block-floating intermediate representations, scale compensation 602 may include exponent adjustment logic, exponent-bias correction logic, normalization logic, rounding logic, saturation logic, underflow or overflow handling logic, or format-control logic. In some examples, scale compensation 602 may be hardwired for a right-shift of two-bit positions. In other examples, scale compensation 602 may be programmable or selectable so that different compensation amounts or rounding modes can be applied.

In some examples, scale compensation 602 may preserve signedness and precision of the combined sum. For example, when the combined sum is represented in two's-complement form, scale compensation 602 may perform arithmetic right-shifting so that sign information is preserved. Scale compensation 602 may also generate guard, round, or sticky information before discarding lower-order bits, and may use that information to perform truncation, round-to-nearest, stochastic rounding, saturation, or another rounding mode. In some examples, scale compensation 602 may maintain the combined sum in an extended-precision representation after compensation so that later scalar application or output conversion can be performed with reduced loss of precision.

In some examples, format-dependent scalar application 604 may apply one or more scalars to the output of scale compensation 602. In some examples, scalars may correspond to block scaling factors associated with FP4 inputs, such as scaling factors used in MXFP4, NVFP4, or another block-scaled FP4 format. For example, operand A values may share a first scalar, operand B values may share a second scalar, and format-dependent scalar application 604 may apply a combined scalar corresponding to the product of the first scalar and the second scalar to the compensated combined sum. In other examples, format-dependent scalar application 604 may apply a scalar associated with only one operand stream, a scalar associated with an activation block, a scalar associated with a weight block, a per-channel scalar, a per-tile scalar, a per-vector scalar, a per-matrix-block scalar, or another scale value used by a neural network computation.

In some examples, format-dependent scalar application 604 may apply scalars in different ways depending on the scale format. For a power-of-two scale format, such as an exponent-only scale, format-dependent scalar application 604 may apply scaling by exponent adjustment, binary-point adjustment, or shifting. For a scale format that includes exponent and mantissa information, format-dependent scalar application 604 may apply scaling using fixed-point multiplication, floating-point multiplication, fused multiply-add circuitry, shift-and-add circuitry, lookup-assisted multiplication, or another scalar application circuit. In some examples, format-dependent scalar application 604 may receive a format signal identifying the scale format and may select the corresponding scalar application path, control value, shift amount, multiplier mode, rounding mode, or output representation based on the format signal.

In some examples, the value provided to format-dependent scalar application 604 is the compensated accumulated dot-product produced after scale compensation 602, and not a per-lane mantissa product or a per-element operand value. Let original FP4 operand values be aᵢ and bᵢ for i=0, . . . , N−1, where N=L×M for the example architecture of FIG. 3. SHAD encoding stage 302 forms scaled operand magnitudes

$${a}_{i}^{′} = 2 {a}_{i} and {b}_{i}^{′} = 2 {b}_{i}$$

for non-zero inputs and represents the scaled magnitudes in the form m×2^{k}, where m∈{1,3}. The SHAD product generation and accumulation circuitry therefore forms an accumulated sum corresponding to

$${\sum }_{i} {a}_{i}^{′} {b}_{i}^{′} = {\sum }_{i} ( 2 {a}_{i} ) ( 2 {b}_{i} ) = 4 {\sum }_{i} {a}_{i} {b}_{i} ,$$

subject to sign handling and any rounding or truncation used by the implementation. Scale compensation 602 removes the fixed factor of four, for example by a right-shift of two bit positions or an equivalent exponent or binary-point adjustment, so that the resulting compensated value corresponds to the unscaled dot-product Σᵢ aᵢ bᵢ before application of any format-level scalar.

In some examples, one or more input groups are associated with respective format-level scalars, and format-dependent scalar application 604 applies those scalars to the compensated accumulated value. For example, a group of FP4 activation values may share a first scalar S_{A}, and a group of FP4 weight values may share a second scalar Sp. If the represented real values are Aᵢ=S_{A}aᵢ and Bᵢ=S_{B}bᵢ, then the represented dot-product is Σᵢ Aᵢ Bᵢ=Σᵢ(S_{A}aᵢ) (S_{B}bᵢ)=S_{A}S_{B} Σᵢ aᵢ bᵢ. After scale compensation 602 produces a compensated sum D corresponding to Σᵢ aᵢ bᵢ, format-dependent scalar application 604 may determine a combined scalar S_{C} and generate an output corresponding to D×S_{C}. In examples in which both operand groups carry scalars, S_{C} may equal S_{A}×S_{B}. In examples in which only one operand group carries a scalar, S_{C} may equal that scalar. More generally, when multiple scalars are associated with a dot-product result, format-dependent scalar application 604 may combine or sequentially apply the scalars so that the output corresponds to the represented numeric value of the source operands.

In some examples, the manner in which S_{C} is determined and applied depends on the scalar format. For an exponent-only scale format, the scalar may represent a power-of-two value S=2^{e}, where e is conveyed by a scale field or other metadata associated with an operand group. When two exponent-only scalars S_{A}=2^{e}^{_{A}} and S_{B}=2^{e}^{_{B}} are used, format-dependent scalar application 604 may combine them by adding exponents to obtain S_{C}=2^{e}^{_{A}}^{+e}^{_{B}}. The compensated sum D may then be rescaled by shifting D left by e_{A}+e_{B}, by adjusting an exponent associated with D, or by changing a binary-point position associated with D. Thus, if D=13, e_{A}=2, and e_{B}=1, then S_{C}=2³=8 and the scaled output corresponds to 13×8=104. In this exponent-only case, no general mantissa multiplication is required in format-dependent scalar application 604, and the scalar path may be implemented using exponent addition together with shifting, exponent update logic, or binary-point control logic.

In some examples, the scalar format includes mantissa information in addition to exponent information, such that the scalar is not restricted to an exact power-of-two. In such examples, a scalar may be represented as S=M_{S}×2^{e}^{_{S}}, where M_{S} is a mantissa value and es is an exponent value, and a combined scalar may be formed as S_{C}=S_{A}×S_{B}. Format-dependent scalar application 604 may therefore determine S_{C} by multiplying mantissas and combining exponents, may normalize or round the resulting scalar representation if appropriate for the format, and may then apply S_{C} to the compensated sum D using fixed-point multiplication circuitry, floating-point multiplication circuitry, fused multiply-add circuitry, shift-and-add circuitry, or other multiplication circuitry. For example, if D=20, S_{A}=1.5×2¹=3, and S_{B}=1.25×2⁰=1.25, then S_{C}=3.75 and the scaled output corresponds to 20×3.75=75. In some examples, format-dependent scalar application 604 may use a format indicator to select between an exponent-only scalar path and a mantissa-bearing scalar path, to select a rounding mode or intermediate precision, and to determine whether scalar combination is performed before or during application to the compensated accumulated value. Positioning format-dependent scalar application 604 after accumulation allows the scalar to be applied once per accumulated dot-product rather than once per lane product, which can reduce duplication of scalar-processing circuitry while preserving the SHAD lane structure for mantissa product selection, exponent-sum shifting, sign handling, zero-gating, and integer-domain accumulation.

In some examples, format-dependent scalar application 604 may be optional because some dot-product operations may not use block scaling factors, because scalars may be applied elsewhere in a compute pipeline, or because downstream circuitry may consume the compensated combined sum directly. When included, format-dependent scalar application 604 may be positioned after scale compensation 602 so that scalars are applied to an accumulated dot-product value rather than separately to each lane product. Applying scalars after accumulation can reduce duplication of scalar hardware across M instances of SHAD multiply elements 502 or L instances of BNA-M SHAD dot-product circuits 304 and can allow lane-level circuitry to remain optimized around product selection, zero-gating, sign handling, exponent-sum shifting, and integer accumulation.

In some examples, convert to output format 606 may convert output of scale compensation 602 or format-dependent scalar application 604 into an output format used by downstream circuitry. Output format may include, for example, an integer format, fixed-point format, floating-point format, block-floating format, FP16 format, BF16 format, FP32 format, FP8 format, FP4 format, accumulator format, internal extended-precision format, or another numeric representation. Convert to output format 606 may include normalization, rounding, saturation, clipping, exponent generation, mantissa generation, sign handling, packing, lane rearrangement, or metadata generation, depending on the output format. Convert to output format 606 may be optional because downstream circuitry may accept an intermediate compensated or scaled representation without conversion.

In some examples, post processing 308 may therefore provide an interface between multiplier-less FP4 dot-product generation and downstream numeric formats or accelerator pipeline stages. Scale compensation 602 can account for encoding stage scaling after accumulation. Format-dependent scalar application 604 can apply block scaling factors or other scalar values based on a selected format. Convert to output format 606 can produce a representation suitable for storage, further arithmetic, accumulation, activation processing, or output. This organization allows SHAD multiply elements 502 and BNA-M SHAD dot-product circuits 304 to remain focused on compact encoded operands and integer-domain product accumulation, while format-specific scaling and representation conversion are handled after dot-product combination.

### Multiplier-Less Dot-Product Computation and SHAD-Based Multiplication

FIG. 7 illustrates multiplier-less process 700 for computing a dot-product, according to some examples of the disclosure. In some examples, operations inside the dashed boundary may be performed for L×M operand pairs, such that L×M lane products are generated before the lane products are combined. Multiplier-less process 700 may be performed by FP4 SHAD dot-product pipe 106, FP4 to SHAD encoding stage 302, BNA-M SHAD dot-product circuit 304, SHAD multiply elements 502, M:1 combiner 560, L:1 combiner 306, post processing 308, or a combination thereof. The operations of FIG. 7 are described with reference to FP4 SHAD dot-product pipe 106 of FIG. 3, BNA-M SHAD dot-product circuit 304 of FIG. 5, SHAD multiply element 502 of FIG. 5, M:1 combiner 560 of FIG. 5, L:1 combiner 306 of FIG. 3, and post processing 308 of FIG. 6 for ease of explanation, although the operations may be performed by other suitable circuitry. Multiplier-less process 700 may be performed after FP4 operands have been encoded into SHAD encoded operands including sign bits, exponent values, mantissa factor bits, and zero indications.

In 702, SHAD multiply element 502 computes a shift amount KP based on exponent value KA and exponent value KB. Performing 702 can include adding KA and KB to generate KP. In some examples, KA and KB are bounded exponent values in the SHAD encoded representation, and KP is therefore bounded to a range of shift amounts, such as 0 to 6. Computing KP based on KA and KB allows multiplication by an exponent-derived power-of-two factor to be implemented using a shift operation rather than a general multiplier.

In 704, SHAD multiply element 502 selects a mantissa product MP based on mantissa factor bits FA and/or FB and (optionally) zero indications ZA and/or ZB. Performing 704 can include selecting MP from a set of possible unsigned mantissa product values. In some examples, when neither ZA nor ZB indicates zero, MP may be selected from 1, 3, or 9 based on FA and FB because each encoded operand has a mantissa factor corresponding to 1 or 3. When ZA or ZB indicates that at least one operand represents zero, MP may be selected as 0. Selecting MP from a limited set of values replaces general mantissa multiplication with product selection logic.

In 706, SHAD multiply element 502 determines the product sign SIGN_OUT. Performing 706 can include determining whether the signs of the encoded operands are the same or different. In some examples, product sign SIGN_OUT may be determined by XORing the sign bit SA of one encoded operand and the sign bit SB of another encoded operand, so that SIGN_OUT indicates whether the corresponding product is positive or negative. Determining the product sign separately from mantissa product selection allows product selection to operate on unsigned values while still supporting signed FP4 products.

In 708, SHAD multiply element 502 converts MP to two's-complement representation. Performing 708 can include conditionally transforming unsigned mantissa product MP based on SIGN_OUT. In some examples, MP may be passed through when SIGN_OUT indicates a positive product, and MP may be inverted and incremented when SIGN_OUT indicates a negative product. Converting MP to two's-complement representation before shifting allows later shifting and accumulation to operate on signed product values.

In 710, SHAD multiply element 502 shifts the signed product by KP. Performing 710 can include applying shift amount KP to the two's-complement representation of MP. In some examples, shifting the signed product by KP generates one lane product for one encoded operand pair. Shifting by KP applies the exponent contribution of the encoded operands after mantissa product selection, thereby generating a product using shift-and-add circuitry rather than a conventional FP4 multiplier.

In some examples, the sequence of operations 708 and 710 reflects a deliberate ordering in which sign conversion precedes exponent-sum shifting. In operation 708, the unsigned mantissa product value MP is conditionally converted to two's-complement form while MP is still an unshifted, narrow value (for example, a 4-bit value representing one of {0, 1, 3, 9} is converted to a 5-bit signed representation). In 710, the signed representation is then shifted left by the shift amount KP, which may range from 0 to 6, to produce the full-width lane product. This ordering means that the two's-complement inversion and increment logic in 708 operates over the pre-shift bit width of the mantissa product (e.g., 5 bits) rather than over the post-shift bit width of the lane product (e.g., 9 bits). In some other multiplier or multiply-accumulate datapaths, sign-magnitude-to-two's-complement conversion may be deferred until the product magnitude is fully formed (for example, after mantissa multiplication and exponent alignment) so that the conversion logic spans the full product width. By performing the conversion in 708 before the magnitude-determining shift in 710, SHAD multiply element 502 can use narrower inversion and increment hardware, which can reduce area and power per lane. Because SHAD multiply elements 502 are replicated M times within each BNA-M SHAD dot-product circuit 304, and BNA-M SHAD dot-product circuits 304 may themselves be replicated across execution units and compute cores, narrowing the sign conversion datapath in each lane can yield a cumulative reduction in circuit area and switching activity across the accelerator.

Two or more operations in 702, 704, and 706 may be performed in parallel or partially in parallel, as shown by the separate branches feeding operations in 708 and 710. For example, KP may be computed from KA and KB while MP is selected from ZA, ZB, FA, and FB, and while SIGN_OUT is determined from operand sign bits. Parallelizing these operations can reduce product generation latency because shift amount generation, mantissa product selection, and sign determination do not need to be performed strictly serially.

In 712, dot-product pipe 106 combines products. Performing 712 can include summing lane products generated for L×M operand pairs. In some examples, M lane products may first be combined by M:1 combiner 560 to generate partial sums, and L partial sums may then be combined by L:1 combiner 306 to generate a combined sum. Combining products may be performed using integer combination circuitry, such as an adder tree, reduction tree, accumulator, or carry-save adder structure. The combined sum may correspond to a dot-product value because it represents a sum of products generated from corresponding pairs of encoded operands.

In 714, post processing 308 compensates for 4× scaling. Performing 714 can include applying a right-shift of two bit positions to the combined sum, adjusting an exponent, changing a binary-point position, or otherwise accounting for scale introduced by SHAD encoding. In some examples, each FP4 operand magnitude is scaled by two during FP4-to-SHAD encoding, so product generation for two encoded operands introduces a factor of four. Compensating for 4× scaling after product combination allows lane product generation and accumulation to remain in an integer representation before compensation is applied.

In 716, post processing 308 applies format-dependent block scaling factors. Performing 716 can include applying one or more scalars associated with a block-scaled FP4 format to the compensated dot-product value. In some examples, block scaling factors may be applied using exponent adjustment or shifting for exponent-only scale formats, or using fixed-point or floating-point multiplication for scale formats that include mantissa information. Applying block scaling factors after product combination allows per-lane product generation to remain optimized around zero-gating, mantissa product selection, sign handling, exponent-sum shifting, and integer accumulation.

In 718, post processing 308 performs format conversion. Performing 718 can include converting the compensated or scaled dot-product value into an output format used by downstream circuitry. In some examples, format conversion may include normalization, rounding, saturation, clipping, exponent generation, mantissa generation, sign handling, packing, or conversion to an integer, fixed-point, floating-point, block-floating, accumulator, or internal output representation. Format conversion allows the output of multiplier-less process 700 to be consumed by subsequent storage, arithmetic, activation, accumulation, or data movement stages.

In some examples, one or more operations in 716 and 718 may be omitted, bypassed, or performed by other post processing circuitry when block scaling or output format conversion is not required.

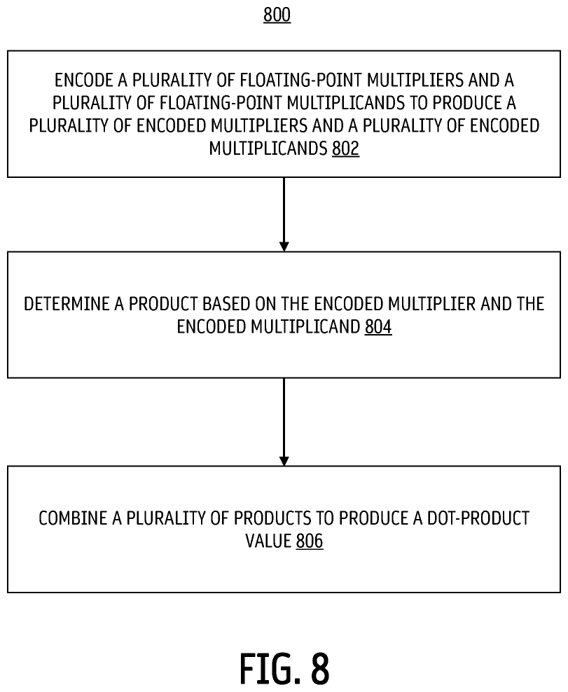

FIG. 8 illustrates method 800 for performing a SHAD-based multiplication, according to some examples of the disclosure. Method 800 may be performed by FP4 SHAD dot-product pipe 106, FP4 to SHAD encoding stage 302, BNA-M SHAD dot-product circuit 304, SHAD multiply elements 502, M:1 combiner 560, L:1 combiner 306, post processing 308, or a combination thereof. Method 800 is described with reference to components of FIGS. 3-6 for ease of explanation, although method 800 may be performed by other suitable circuitry.

In 802, FP4 to SHAD encoding stage 302 encodes a plurality of floating-point multipliers and a plurality of floating-point multiplicands to produce a plurality of encoded multipliers and a plurality of encoded multiplicands. Performing 802 can include encoding each floating-point multiplier to produce an encoded multiplier having a sign bit, two exponent bits, and a mantissa bit indicating whether a mantissa factor corresponds to 1 or 3. Performing 802 can also include encoding each floating-point multiplicand to produce an encoded multiplicand having a further sign bit, two further exponent bits, and a further mantissa bit indicating whether a further mantissa factor corresponds to 1 or 3. In some examples, performing 802 may include generating zero indications for encoded multipliers and encoded multiplicands, so that downstream product generation circuitry can identify zero-valued operands.

Encoding in 802 may convert FP4 operand magnitudes into a SHAD encoded representation that preserves exponent-derived shift information and reduces mantissa information to a one-bit mantissa factor indication. In some examples, this allows downstream multiplication to use product selection and exponent-sum shifting rather than a conventional mantissa multiplier. Encoding in 802 may be performed using dedicated encoders, shared encoders, a look-up table, combinational logic, pipelined encoder circuitry, buffered encoder circuitry, or any suitable combination thereof.

In 804, SHAD multiply element 502 determines a product based on an encoded multiplier and an encoded multiplicand. Performing 804 can include selecting an unsigned mantissa product value based on the mantissa bit of the encoded multiplier, the further mantissa bit of the encoded multiplicand, and a zero-gating signal. In some examples, the unsigned mantissa product value may be selected from a set including 0, 1, 3, and 9, with 0 selected when the zero-gating signal indicates that at least one of the encoded multiplier or the encoded multiplicand represents zero.

Determining the product in 804 may further include generating the product based on the unsigned mantissa product value, the two exponent bits, the two further exponent bits, and a sign of the product. For example, SHAD multiply element 502 may add the exponent bits of the encoded multiplier and the exponent bits of the encoded multiplicand to produce a shift amount and may shift a signed representation of the selected unsigned mantissa product value by the shift amount. The shift amount may be bounded because the encoded exponent values are bounded in the SHAD encoded representation. In some examples, the shift amount may be no more than 6.

Determining the product in 804 may also include computing an XOR of the sign bit and the further sign bit to determine the sign of the product. When the sign of the product indicates a negative product, SHAD multiply element 502 may conditionally invert the selected unsigned mantissa product value and add one to produce a signed mantissa product value before shifting. This allows product selection to be performed on a small unsigned mantissa product set while still producing signed lane products for accumulation.

In 806, BNA-M SHAD dot-product circuit 304, M:1 combiner 560, L:1 combiner 306, or another lane product combination circuit combines a plurality of products to produce a dot-product value. Performing 806 can include summing products generated from corresponding pairs of encoded multipliers and encoded multiplicands. In some examples, M lane products may be combined to produce a partial sum, and one or more partial sums may be combined to produce the dot-product value. The dot-product value may therefore correspond to a sum of products for a plurality of corresponding multiplier-multiplicand pairs.

Combining products in 806 may be performed in an integer representation. For example, lane products produced by SHAD multiply elements 502 may be summed using an integer adder tree, reduction tree, accumulator, carry-save adder structure, or other integer combination circuitry. Because the lane products may be generated using selected mantissa product values and exponent-derived shifts, method 800 can maintain integer-domain product accumulation before any post processing compensation or output format conversion is applied.

In some examples, method 800 may further include post processing the dot-product value after 806. Post processing can include right-shifting the dot-product value or an accumulated sum by two bit positions to compensate for scaling introduced during encoding, applying one or more block scaling factors, or converting the dot-product value to an output format. These post processing operations may be performed after product combination so that the per-lane product generation path remains focused on mantissa product selection, zero-gating, sign handling, exponent-sum shifting, and integer accumulation.

### Exemplary Computing Device

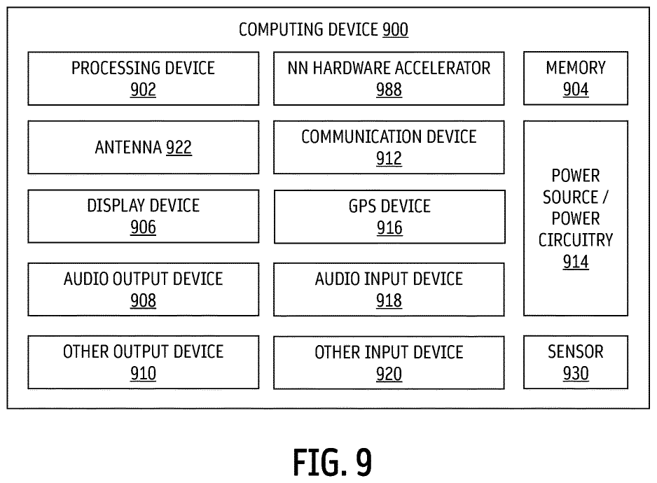

FIG. 9 is a block diagram of an apparatus or a system, e.g., an exemplary computing device 900, according to some examples of the disclosure. One or more computing devices 900 may be used to implement the functionalities described with the FIGS. and herein. A number of components are illustrated in the FIGS. that can be included in computing device 900, but any one or more of these components may be omitted or duplicated, as suitable for the application. In some examples, some or all of the components included in computing device 900 may be attached to one or more motherboards. In some examples, some or all of these components are fabricated onto a single system-on-chip die. Additionally, in various examples, computing device 900 may not include one or more of the components illustrated in FIG. 9, and computing device 900 may include interface circuitry for coupling to the one or more components. For example, computing device 900 may not include a display device 906, and may include display device interface circuitry (e.g., a connector and driver circuitry) to which a display device 906 may be coupled. In another set of examples, computing device 900 may not include an audio input device 918 or an audio output device 908 and may include audio input or output device interface circuitry (e.g., connectors and supporting circuitry) to which an audio input device 918 or audio output device 908 may be coupled.

Computing device 900 may include a processing device 902 (e.g., one or more processing devices, one or more of the same type of processing device, one or more of different types of processing devices). The processing device 902 may include electronic circuitry that processes electronic data from data storage elements (e.g., registers, memory, resistors, capacitors, quantum bit cells) to transform that electronic data into other electronic data that may be stored in registers and/or memory. Examples of processing device 902 may include a CPU, a GPU, a quantum processor, a machine learning processor, an artificial intelligence processor, a neural network processor, an artificial intelligence accelerator, an application-specific integrated circuit (ASIC), an analog signal processor, an analog computer, a microprocessor, a digital signal processor, a FPGA, a TPU, a Data Processing Unit (DPU), etc.

In some examples, computing device 900 may include NN hardware accelerator 988. NN hardware accelerator 988 can interface with processing device 902 to accelerate inference, training, artificial intelligence, machine learning, graphics, signal processing, image processing, video processing, data processing, networking, security, compression, decompression, or other compute operations. In some examples, NN hardware accelerator 988 may be implemented as one or more of a neural network accelerator, artificial intelligence accelerator, machine learning accelerator, graphics processing unit, image signal processor, video processing unit, digital signal processor, data processing unit, infrastructure processing unit, network processing unit, security accelerator, cryptographic accelerator, compression accelerator, decompression accelerator, or other multi-tile or multi-agent processing device. NN hardware accelerator 988 may include NN hardware accelerator 100 of FIG. 1.

NN hardware accelerator 988 may include one or more compute cores, such as compute core 102 of FIG. 1, one or more execution units, such as execution unit 104 of FIG. 1, and one or more FP4 SHAD dot-product pipes, such as FP4 SHAD dot-product pipe 106 of FIGS. 1 and 3. NN hardware accelerator 988 may also include one or more FP4 to SHAD encoding stages, such as FP4 to SHAD encoding stage 302 of FIG. 3 or SHAD encoding stage 302 of FIGS. 4A and 4B, one or more FP4 to SHAD encoders, such as FP4 to SHAD encoder 404 of FIGS. 4A and 4B, and one or more buffers, such as buffer 408 of FIG. 4B. NN hardware accelerator 988 may further include one or more BNA-M SHAD dot-product circuits, such as BNA-M SHAD dot-product circuit 304 of FIG. 5, one or more SHAD multiply elements, such as SHAD multiply element 502 of FIG. 5, one or more zero-detection circuits, such as zero-detection logic 540 of FIG. 5, one or more product selectors, such as product select 506 of FIG. 5, one or more sign determination circuits, such as XOR circuit 508 of FIG. 5, one or more two's-complement transformation circuits, such as two's complement circuit 510 of FIG. 5, one or more exponent addition circuits, such as add circuit 512 of FIG. 5, one or more shifters, such as shifter 514 of FIG. 5, one or more lane product combination circuits, such as M:1 combiner 560 of FIG. 5 or L:1 combiner 306 of FIG. 3, and one or more post processing circuits, such as post processing 308 of FIG. 6. NN hardware accelerator 988 may further include memory subsystem 110, shared cache 120, interconnect 130, control logic, data movement circuitry, or combinations thereof. In some examples, one or more of these components may be implemented in NN hardware accelerator 988 as hardware logic, firmware-controlled hardware, programmable interconnect logic, or combinations thereof.

Computing device 900 may include a memory 904, which may itself include one or more memory devices such as volatile memory (e.g., DRAM), nonvolatile memory (e.g., ROM), HBM, flash memory, solid-state memory, and/or a hard drive. Memory 904 includes one or more non-transitory computer-readable storage media. In some examples, memory 904 may include memory that shares a die with the processing device 902.

In some examples, memory 904 includes one or more non-transitory computer-readable media storing instructions executable to perform operations described with the FIGS. and herein. Memory 904 may store instructions that generate inputs to NN hardware accelerator 988. Memory 904 may store instructions that process outputs from NN hardware accelerator 988. In some examples, memory 904 may store instructions that can cause NN hardware accelerator 988 and/or processing device 902 to perform one or more operations illustrated in FIGS. 2-8. The instructions stored in the one or more non-transitory computer-readable media may be executed by processing device 902.

Memory 904 may store instructions, data, parameters, intermediate values, and control information used by computing device 900 or NN hardware accelerator 988. In some examples, memory 904 may store FP4 operands, encoded SHAD operands, weights, activations, scaling factors, format indicators, dot-product outputs, partial sums, accumulated sums, or output format values associated with FP4 SHAD dot-product pipe 106 of FIGS. 1 and 3. Memory 904 may also store data used by FP4 to SHAD encoding stage 302 of FIG. 3 or FP4 to SHAD encoding stage 302 of FIGS. 4A and 4B, including operand streams, encoded operand groups, sign bits, exponent values, mantissa factor bits, zero indications, zero-gating information, or other per-element information used to generate lane products.

Memory 904 may include or be associated with one or more look-up tables, buffers, queues, registers, caches, scratchpads, or other storage structures. For example, memory 904 may store a look-up table used by FP4 to SHAD encoder 404 of FIGS. 4A and 4B to map FP4 input bits to SHAD encoded fields, such as sign bit SA or SB, exponent value KA or KB, mantissa factor bit FA or FB, and zero indication ZA or ZB. As another example, memory 904 may include buffer 408 of FIG. 4B or may store information used by buffer 408, including encoded operand values A′[0, . . . , L×M−1] or corresponding encoded B operand values. In some examples, memory 904 may support double buffering, such that one buffer region receives encoded operands from FP4 to SHAD encoders 404 of FIG. 4B while another buffer region provides a previously collected group of encoded operands to FP4 SHAD dot-product pipe 106 of FIG. 3.

Memory 904 may also store intermediate values generated within BNA-M SHAD dot-product circuit 304 of FIG. 5. For example, memory 904 may store or temporarily hold mantissa product values MP selected by product select 506 of FIG. 5, product signs SIGN_OUT generated by XOR circuit 508 of FIG. 5, signed mantissa product values generated by two's complement circuit 510 of FIG. 5, shift amounts KP generated by add circuit 512 of FIG. 5, lane products output by shifter 514 of FIG. 5, partial sums generated by M:1 combiner 560 of FIG. 5, and combined sums generated by L:1 combiner 306 of FIG. 3. Memory 904 may further store post processing information for post processing 308 of FIG. 6, such as compensation parameters for scale compensation 602, format indicators and scalars for format-dependent scalar application 604, and output format metadata for convert to output format 606.

In some examples, memory 904 may store data, e.g., data structures, binary data, bits, metadata, files, blobs, etc., as described with the FIGS. and herein. Data may include inputs and/or outputs to NN hardware accelerator 988 (e.g., input tensors, output tensors, input activations, output feature maps, weights of weight matrices, parameters of operations, etc.).

In some examples, computing device 900 may include a communication device 912 (e.g., one or more communication devices). For example, communication device 912 may be configured for managing wired and/or wireless communications for the transfer of data to and from computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not include any wires, although in some examples they might not. Communication device 912 may implement any of a number of wireless standards or protocols. Computing device 900 may include an antenna 922 to facilitate wireless communications and/or to receive other wireless communications (such as radio frequency transmissions). Computing device 900 may include receiver circuits and/or transmitter circuits. In some examples, the communication device 912 may manage wired communications, such as electrical, optical, or any other suitable communication protocols (e.g., Ethernet). As noted above, the communication device 912 may include multiple communication chips. For instance, a first communication device 912 may be dedicated to shorter-range wireless communications such as Wi-Fi or Bluetooth, and a second communication device 912 may be dedicated to longer-range wireless communications. In some examples, a first communication device 912 may be dedicated to wireless communications, and a second communication device 912 may be dedicated to wired communications.

Computing device 900 may include power source/power circuitry 914. The power source/power circuitry 914 may include one or more energy storage devices (e.g., batteries or capacitors) and/or circuitry for coupling components of computing device 900 to an energy source separate from computing device 900 (e.g., DC power, AC power, etc.).

Computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

Computing device 900 may include an audio output device 908 (or corresponding interface circuitry, as discussed above). The audio output device 908 may include any device that generates an audible indicator, such as speakers, headsets, or earbuds, for example.

Computing device 900 may include an audio input device 918 (or corresponding interface circuitry, as discussed above). The audio input device 918 may include any device that generates a signal representative of a sound, such as microphones, microphone arrays, or digital instruments (e.g., instruments having a musical instrument digital interface (MIDI) output).

Computing device 900 may include a GPS device 916 (or corresponding interface circuitry, as discussed above). The GPS device 916 may be in communication with a satellite-based system and may receive a location of computing device 900, as known in the art.

Computing device 900 may include a sensor 930 (or one or more sensors). Computing device 900 may include corresponding interface circuitry, as discussed above). Sensor 930 may sense physical phenomena and translate the physical phenomenon into electrical signals that can be processed by, e.g., processing device 902. Examples of sensor 930 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 900 may include another output device 910 (or corresponding interface circuitry, as discussed above). Examples of the other output device 910 may include an audio codec, a video codec, a printer, a wired or wireless transmitter for providing information to other devices, haptic output device, gas output device, vibrational output device, lighting output device, home automation controller, or an additional storage device.

Computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 900 may have any desired form factor, such as a handheld or mobile computer system (e.g., a cell phone, a smartphone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some examples, computing device 900 may be any other electronic device that processes data.

### Select Examples

Example 1 provides an accelerator including one or more compute cores, where a compute core includes one or more execution units, and an execution unit includes one or more dot-product circuits; where a dot-product circuit includes an encoding stage to receive floating-point multipliers and floating-point multiplicands and to output encoded multipliers and encoded multiplicands, where an encoded multiplier includes a sign bit, two exponent bits, and a mantissa bit, and an encoded multiplicand includes a further sign bit, two further exponent bits, and a further mantissa bit; a plurality of shift-and-add circuits to output a plurality of lane products, where a shift-and-add circuit selects an unsigned mantissa product value from a set of values based on the mantissa bit and the further mantissa bit, and the shift-and-add circuit outputs a lane product based on the unsigned mantissa product value; and a lane product combination circuit to combine the plurality of lane products.

Example 2 provides the accelerator of example 1, where the mantissa bit indicates whether a mantissa factor corresponds to 1 or 3, and the further mantissa bit whether a further mantissa factor corresponds to 1 or 3.

Example 3 provides the accelerator of example 1 or 2, where the set of values includes 1, 3, and 9.

Example 4 provides the accelerator of any one of examples 1-3, where the shift-and-add circuit selects the unsigned mantissa product value further based on a zero-gating signal.

Example 5 provides the accelerator of any one of examples 1-3, where the shift-and-add circuit further includes an adder circuit to generate a shift amount as a sum of the two exponent bits and the two further exponent bits; and a shifter circuit to apply the shift amount to a signed representation of the unsigned mantissa product value to produce the lane product.

Example 6 provides the accelerator of example 5, where the shift-and-add circuit further includes an XOR circuit to determine a sign of the lane product based on the sign bit and the further sign bit; and a 2's complement transformation circuit to transform the unsigned mantissa product value based on the sign of the lane product and to output the signed representation of the unsigned mantissa product value, where the signed representation of the unsigned mantissa product value is provided as input to the shifter circuit.

Example 7 provides the accelerator of example 6, where the 2's complement transformation circuit outputs a 5-bit value, and the shifter circuit outputs a 9-bit value.

Example 8 provides the accelerator of any one of examples 1-6, where the dot-product circuit further includes a post processing circuit to apply a right shift of two bit positions to an output of the lane product combination circuit to compensate for a scaling factor introduced by the encoding stage.

Example 9 provides the accelerator of any one of examples 1-8, where the dot-product circuit further includes a post processing circuit to apply one or more block scaling factors to an output of the lane product combination circuit.

Example 10 provides a dot-product circuit including an encoding stage to receive a plurality of multipliers and a plurality of multiplicands and to output a plurality of encoded multipliers and a plurality of encoded multiplicands, where an encoded multiplier includes a sign bit, two exponent bits, and a mantissa bit, and an encoded multiplicand includes a further sign bit, two further exponent bits, and a further mantissa bit; a product generation circuit including a plurality of lanes, where a lane includes a product selector to select an unsigned mantissa product value from a set of values based on the mantissa bit and the further mantissa bit, and the lane outputs a lane product for the encoded multiplier and the encoded multiplicand based on the unsigned mantissa product value; and a lane product combination circuit to combine a plurality of lane products generated by the plurality of lanes and to output a dot-product.

Example 11 provides the dot-product circuit of example 10, where the mantissa bit indicates whether a mantissa factor corresponds to 1 or 3, and the further mantissa bit whether a further mantissa factor corresponds to 1 or 3.

Example 12 provides the dot-product circuit of example 10 or 11, where the set of values includes 1, 3, and 9.

Example 13 provides the dot-product circuit of any one of examples 10-12, where: the lane further includes zero-detection logic to generate a zero-gating signal based on the encoded multiplier and the encoded multiplicand; and the product selector selects the unsigned mantissa product value as 0 based on the zero-gating signal indicating at least one of the encoded multiplier and the encoded multiplicand is 0.

Example 14 provides the dot-product circuit of any one of examples 10-13, where the lane further includes an exponent addition circuit to generate a shift amount based on a sum of the two exponent bits and the two further exponent bits; and a shifter to shift a signed representation of the unsigned mantissa product value by the shift amount.

Example 15 provides the dot-product circuit of example 14, where the signed representation of the unsigned mantissa product value is generated by a 2's complement transformation circuit based on a sign of the lane product.

Example 16 provides the dot-product circuit of example 15, where the 2's complement transformation circuit outputs a 5-bit value, and the shifter outputs a 9-bit value.

Example 17 provides the dot-product circuit of any one of examples 14-16, where the shift amount is represented by three bits.

Example 18 provides the dot-product circuit of any one of examples 10-17, where the lane further includes an XOR circuit to determine a sign of the lane product based on the sign bit and the further sign bit; and a 2's complement transformation circuit to transform the unsigned mantissa product value based on the sign of the lane product and to output a signed representation of the unsigned mantissa product value.

Example 19 provides the dot-product circuit of any one of examples 10-18, where the product selector includes a multiplexer to select the unsigned mantissa product value from the set of values based on the mantissa bit and the further mantissa bit.

Example 20 provides the dot-product circuit of any one of examples 10-19, where the lane product combination circuit includes an adder tree.

Example 21 provides the dot-product circuit of any one of examples 10-20, further including one or more further product generation circuits and one or more corresponding lane product combination circuits to output one or more further dot-products; and a combiner circuit to combine the dot-product and the one or more further dot-products.

Example 22 provides the dot-product circuit of any one of examples 10-21, where the encoding stage includes one or more encoders to encode the plurality of multipliers and the plurality of multiplicands.

Example 23 provides the dot-product circuit of any one of examples 10-22, further including a post processing circuit to apply a right shift of two bit positions.

Example 24 provides the dot-product circuit of any one of examples 10-23, further including a post processing circuit to apply one or more scalars to the dot-product.

Example 25 provides a shift-and-add circuit to implement multiplication, including a receive interface to receive an encoded multiplier and an encoded multiplicand, where the encoded multiplier includes a sign bit, two exponent bits, and a mantissa bit, and the encoded multiplicand includes a further sign bit, two further exponent bits, and a further mantissa bit; a product selector to select an unsigned mantissa product value from a set based on the mantissa bit and the further mantissa bit; an adder circuit to generate a shift amount based on the two exponent bits and the two further exponent bits; and a shifter circuit to apply the shift amount to a signed representation of the unsigned mantissa product value and output a product.

Example 26 provides the shift-and-add circuit of example 25, where the mantissa bit indicates whether a mantissa factor corresponds to 1 or 3, and the further mantissa bit whether a further mantissa factor corresponds to 1 or 3.

Example 27 provides the shift-and-add circuit of example 25 or 26, where the set includes 1, 3, and 9.

Example 28 provides the shift-and-add circuit of any one of examples 25-27, further including zero-detection logic to detect whether at least one of the encoded multiplier and the encoded multiplicand represents 0 and output a zero-gating signal; where the product selector selects the unsigned mantissa product value as 0 based on the zero-gating signal indicating at least one of the encoded multiplier and the encoded multiplicand is 0.

Example 29 provides the shift-and-add circuit of any one of examples 25-28, further including an XOR circuit to determine a sign of the product based on the sign bit and the further sign bit; and a 2's complement transformation circuit to transform the unsigned mantissa product value based on the sign of the product and to output the signed representation of the unsigned mantissa product value.

Example 30 provides the shift-and-add circuit of any one of examples 25-29, where the shift amount is bounded to a range of 0 to 6.

Example 31 provides the shift-and-add circuit of any one of examples 25-30, where the product selector includes a multiplexer to select from the set based on the mantissa bit and the further mantissa bit.

Example 32 provides the shift-and-add circuit of any one of examples 25-31, where the signed representation of the unsigned mantissa product value is a 5-bit value generated by a 2's complement transformation circuit and the product generated by the shifter circuit is a 9-bit value.

Example 33 provides a method to perform shift-and-add based multiplication, including encoding a plurality of floating-point multipliers and a plurality of floating-point multiplicands to produce a plurality of encoded multipliers and a plurality of encoded multiplicands, where encoding a floating-point multiplier produces an encoded multiplier having a sign bit, two exponent bits, and a mantissa bit, and encoding a floating-point multiplicand produces an encoded multiplicand having a further sign bit, two further exponent bits, and a further mantissa bit; determining a product based on the encoded multiplier and the encoded multiplicand, where determining the product includes selecting an unsigned mantissa product value from a set based on the mantissa bit and the further mantissa bit; and generating the product based on the unsigned mantissa product value, the two exponent bits, the two further exponent bits, and a sign of the product determined based on the sign bit and the further sign bit; and combining a plurality of products to produce a dot-product value.

Example 34 provides the method of example 33, where the mantissa bit indicates whether a mantissa factor corresponds to 1 or 3, and the further mantissa bit whether a further mantissa factor corresponds to 1 or 3.

Example 35 provides the method of example 33 or 34, where the set includes 1, 3, and 9.

Example 36 provides the method of any one of examples 33-35, where selecting the unsigned mantissa product value from the set includes selecting the unsigned mantissa product further based on a zero-gating signal.

Example 37 provides the method of any one of examples 33-36, where generating the product includes adding the two exponent bits and the two further exponent bits to produce a shift amount; and shifting the unsigned mantissa product value by the shift amount.

Example 38 provides the method of example 37, where the shift amount is no more than 6.

Example 39 provides the method of any one of examples 33-38, where generating the product further includes computing an XOR of the sign bit and the further sign bit to determine the sign of the product; and conditionally inverting the unsigned mantissa product value and adding one responsive to the sign of the product indicating a negative product to produce a signed mantissa product value prior to the shifting.

Example 40 provides the method of any one of examples 33-39, where combining the plurality of products includes summing the plurality of products using an integer adder tree to produce a sum of the plurality of products in an integer representation.

Example 41 provides the method of example 40, further including right-shifting the sum of the plurality of products by two bit positions.

Example 42 provides a method, including receiving a first operand and a second operand each encoded as a sign bit, an exponent-related field, and a mantissa-selector bit; selecting a partial product from a predetermined set of values based on the mantissa-selector bits; shifting the partial product by a sum of the exponent-related fields; and accumulating shifted results to produce a dot product.

Example 43 provides the method of example 42, where the predetermined set of values includes 0, 1, 3, and 9.

Example 44 provides the method of example 42 or 43, where selecting the partial product includes selecting 1 when both mantissa-selector bits indicate mantissa factors of 1; selecting 3 when one of the mantissa-selector bits indicates a mantissa factor of 3 and another of the mantissa-selector bits indicates a mantissa factor of 1; and selecting 9 when both mantissa-selector bits indicate mantissa factors of 3.

Example 45 provides the method of any one of examples 42-44, further including generating a zero-gating signal indicating that at least one of the first operand or the second operand represents zero; where selecting the partial product includes selecting zero based on the zero-gating signal.

Example 46 provides the method of example 45, further including using the zero-gating signal to reduce switching activity in one or more of: product selection logic, sign-generation logic, two's-complement transformation logic, shifter logic, lane-product output logic, and accumulation logic.

Example 47 provides the method of any one of examples 42-46, where: the exponent-related fields each include two bits; and the sum of the exponent-related fields is represented by a three-bit shift amount.

Example 48 provides the method of example 47, where the three-bit shift amount is bounded to a range of 0 to 6.

Example 49 provides the method of any one of examples 42-48, further including determining a sign of the partial product based on an exclusive-OR of the sign bit of the first operand and the sign bit of the second operand.

Example 50 provides the method of example 49, further including conditionally transforming the partial product into a two's-complement signed representation based on the sign before shifting the partial product.

Example 51 provides the method of example 50, where conditionally transforming the partial product includes transforming a four-bit unsigned value into a five-bit signed value before shifting.

Example 52 provides the method of example 51, where shifting the partial product includes shifting the five-bit signed value to produce a nine-bit signed lane product.

Example 53 provides the method of any one of examples 50-52, where the two's-complement signed representation is generated before the shifting.

Example 54 provides the method of any one of examples 42-53, where accumulating the shifted results includes summing the shifted results using integer addition.

Example 55 provides the method of any one of examples 42-54, where accumulating the shifted results includes combining a plurality of shifted results using a combiner to produce a partial dot-product and combining the partial dot-product with one or more further partial dot-products using a further combiner.

Example 56 provides the method of any one of examples 42-55, further including after accumulating the shifted results, applying a right-shift of two bit positions to compensate for scaling introduced by encoding the first operand and the second operand.

Example 57 provides the method of example 56, where applying the right-shift of two bit positions includes applying the right-shift to an accumulated sum after integer-domain accumulation of a plurality of shifted results.

Example 58 provides the method of any one of examples 42-57, further including applying one or more block scaling factors to the dot product after accumulating the shifted results.

Example 59 provides the method of example 58, where applying the one or more block scaling factors includes applying a combined scalar associated with an activation block and a weight block.

Example 60 provides the method of example 58 or 59, where applying the one or more block scaling factors includes using exponent adjustment or shifting for an exponent-only scale format.

Example 61 provides the method of any one of examples 58-60, where applying the one or more block scaling factors includes using one or more of fixed-point multiplication, floating-point multiplication, fused multiply-add circuitry, shift-and-add circuitry, and lookup-assisted multiplication for a scale format including mantissa information.

Example 62 provides the method of any one of examples 42-61, further including converting the dot product to an output numeric format after accumulating the shifted results.

Example 63 provides the method of example 62, where converting the dot product includes performing one or more of normalization, rounding, saturation, clipping, exponent generation, mantissa generation, sign handling, and packing.

Example 64 provides the method of any one of examples 42-63, where the first operand and the second operand are generated by encoding respective FP4 operands into a scaled representation in which each non-zero magnitude is represented as m×2^{k}, where m is 1 or 3.

Example 65 provides the method of example 64, where encoding the respective FP4 operands includes scaling FP4 magnitudes by two before representing the FP4 magnitudes as m×2^{k}

Example 66 provides the method of any one of examples 42-65, where the first operand and the second operand are received from a buffer that stores encoded operands generated by a shared encoder array.

Example 67 provides the method of example 66, where the shared encoder array encodes fewer operands per cycle than a total number of operand positions used to produce the dot product, and the buffer accumulates encoded operands over multiple cycles.

Example 68 provides the method of any one of examples 42-64, where the mantissa-selector bit indicates whether m is 1 or 3.

Example 69 provides an apparatus including means for performing a method according to any one of examples 33-68.

### Variations and Remarks

Although the operations of the example method shown in and described with reference to FIGS. are illustrated as occurring once each and in a particular order, it will be recognized that the operations may be performed in any suitable order and repeated as desired. Additionally, one or more operations may be performed in parallel. Furthermore, the operations illustrated in FIGS. may be combined or may include more or fewer details than described.

As used herein, the word “each,” when used to describe a set of elements or operations, is used for ease of understanding and does not necessarily require that every element or operation in the set exhibits the described characteristic or undergoes the described processing. Unless explicitly stated otherwise, a reference to “each” element in a set should be understood to mean “one or more” or “any” of the elements in the set, and does not impose a requirement that the described feature apply universally to all members of the set.

The various implementations described herein may refer to artificial intelligence, machine learning, and deep learning. Deep learning may be a subset of machine learning. Machine learning may be a subset of artificial intelligence. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed:

1. An accelerator comprising:
one or more compute cores, wherein a compute core comprises one or more execution units, and an execution unit comprises one or more dot-product circuits;
wherein a dot-product circuit comprises:
an encoding stage to receive floating-point multipliers and floating-point multiplicands and to output encoded multipliers and encoded multiplicands, wherein an encoded multiplier includes a sign bit, two exponent bits, and a mantissa bit, and an encoded multiplicand includes a further sign bit, two further exponent bits, and a further mantissa bit;
a plurality of shift-and-add circuits to output a plurality of lane products, wherein a shift-and-add circuit selects an unsigned mantissa product value from a set of values based on the mantissa bit and the further mantissa bit, and the shift-and-add circuit outputs a lane product based on the unsigned mantissa product value; and
a lane product combination circuit to combine the plurality of lane products.

2. The accelerator of claim 1, wherein the mantissa bit indicates whether a mantissa factor corresponds to 1 or 3, and the further mantissa bit whether a further mantissa factor corresponds to 1 or 3.

3. The accelerator of claim 1, wherein the set of values includes 1, 3, and 9.

4. The accelerator of claim 1, wherein the shift-and-add circuit selects the unsigned mantissa product value further based on a zero-gating signal.

5. The accelerator of claim 1, wherein the shift-and-add circuit further comprises:
an adder circuit to generate a shift amount as a sum of the two exponent bits and the two further exponent bits; and
a shifter circuit to apply the shift amount to a signed representation of the unsigned mantissa product value to produce the lane product.

6. The accelerator of claim 5, wherein the shift-and-add circuit further comprises:
an XOR circuit to determine a sign of the lane product based on the sign bit and the further sign bit; and
a 2's complement transformation circuit to transform the unsigned mantissa product value based on the sign of the lane product and to output the signed representation of the unsigned mantissa product value, wherein the signed representation of the unsigned mantissa product value is provided as input to the shifter circuit.

7. The accelerator of claim 6, wherein the 2's complement transformation circuit outputs a 5-bit value, and the shifter circuit outputs a 9-bit value.

8. The accelerator of claim 1, wherein the dot-product circuit further comprises a post processing circuit to apply a right shift of two bit positions to an output of the lane product combination circuit to compensate for a scaling factor introduced by the encoding stage.

9. The accelerator of claim 1, wherein the dot-product circuit further comprises a post processing circuit to apply one or more block scaling factors to an output of the lane product combination circuit.

10. A dot-product circuit comprising:
an encoding stage to receive a plurality of multipliers and a plurality of multiplicands and to output a plurality of encoded multipliers and a plurality of encoded multiplicands, wherein an encoded multiplier includes a sign bit, two exponent bits, and a mantissa bit, and an encoded multiplicand includes a further sign bit, two further exponent bits, and a further mantissa bit;
a product generation circuit comprising a plurality of lanes, wherein a lane comprises a product selector to select an unsigned mantissa product value from a set of values based on the mantissa bit and the further mantissa bit, and the lane outputs a lane product for the encoded multiplier and the encoded multiplicand based on the unsigned mantissa product value; and
a lane product combination circuit to combine a plurality of lane products generated by the plurality of lanes and to output a dot-product.

11. The dot-product circuit of claim 10, wherein the mantissa bit indicates whether a mantissa factor corresponds to 1 or 3, and the further mantissa bit whether a further mantissa factor corresponds to 1 or 3.

12. The dot-product circuit of claim 10, wherein the set of values includes 1, 3, and 9.

13. The dot-product circuit of claim 10, wherein:
the lane further comprises zero-detection logic to generate a zero-gating signal based on the encoded multiplier and the encoded multiplicand; and
the product selector selects the unsigned mantissa product value as 0 based on the zero-gating signal indicating at least one of the encoded multiplier and the encoded multiplicand is 0.

14. The dot-product circuit of claim 10, wherein the lane further comprises:
an exponent addition circuit to generate a shift amount based on a sum of the two exponent bits and the two further exponent bits; and
a shifter to shift a signed representation of the unsigned mantissa product value by the shift amount.

15. The dot-product circuit of claim 14, wherein the signed representation of the unsigned mantissa product value is generated by a 2's complement transformation circuit based on a sign of the lane product.

16. The dot-product circuit of claim 15, wherein the 2's complement transformation circuit outputs a 5-bit value, and the shifter outputs a 9-bit value.

17. The dot-product circuit of claim 14, wherein the shift amount is represented by three bits.

18. The dot-product circuit of claim 10, wherein the lane further comprises:
an XOR circuit to determine a sign of the lane product based on the sign bit and the further sign bit; and
a 2's complement transformation circuit to transform the unsigned mantissa product value based on the sign of the lane product and to output a signed representation of the unsigned mantissa product value.

19. A shift-and-add circuit to implement multiplication, comprising:
a receive interface to receive an encoded multiplier and an encoded multiplicand, wherein the encoded multiplier includes a sign bit, two exponent bits, and a mantissa bit, and the encoded multiplicand includes a further sign bit, two further exponent bits, and a further mantissa bit;
a product selector to select an unsigned mantissa product value from a set based on the mantissa bit and the further mantissa bit;
an adder circuit to generate a shift amount based on the two exponent bits and the two further exponent bits; and
a shifter circuit to apply the shift amount to a signed representation of the unsigned mantissa product value and output a product.

20. The shift-and-add circuit of claim 19, wherein the mantissa bit indicates whether a mantissa factor corresponds to 1 or 3, and the further mantissa bit whether a further mantissa factor corresponds to 1 or 3.
